(19) United States
(12) Patent Application Publication
(10) Pub. No.: US 2017/0097625 A1
(43) Pub. Date: Apr. 6, 2017

(54) OPERATION PROCEDURE MANAGEMENT METHOD AND SYSTEM

(71) Applicant: HITACHI, LTD., Tokyo (JP)

(72) Inventors: Pulung WASKITO, Tokyo (JP); Kimitaka TAMURA, Tokyo (JP)

(73) Assignee: HITACHI, LTD., Tokyo (JP)

(21) Appl. No.: 15/126,750

(22) PCT Filed: Jun. 19, 2014
(86) PCT No.: PCT/JP2014/066360

§ 371 Date: Sep. 16, 2016

(51) Int. Cl. G05B 19/042

(52) U.S. Cl. CPC G05B 19/0426; G05B 2219/36056

(57) ABSTRACT

An operation procedure management method and system effectively prevents degradation of the operation quality and the occurrence of accidents includes a plurality of client terminals, and a server system for providing information regarding operation procedures to each of a plurality of operators. A first processing unit stores and manages information regarding a diversion relation between the operation procedures in storage apparatuses and, upon a change of one of the operation procedures, searches for other operation procedures having the diversion relation with the changed operation procedure on the basis of the diversion-related information and transmitting changed contents as a change notification to the client terminal retained by the operator who conducts the operation procedure detected by the search; and a second processing unit which has received the change notification, displays a message according to the changed contents of the operation procedure on an output device at an appropriate timing.

### TECHNICAL FIELD

The present invention relates to an operation procedure management method and system and is suited for use in, for example, an operation procedure management system for managing a plurality of operation procedures conducted at different sites.

### BACKGROUND ART

Conventionally, when an operator proceeds with an operation at a site by referring to documents, they often divert documents previously prepared as the above-mentioned documents in order to enhance production efficiency and quality, reduce cost, and prevent a mistake. In this case such diversion is occasionally conducted not only with respect to the documents but also on the basis of a task composed of a plurality of operation procedures or an operation procedure composed of a series of tasks.

When the diversion of a document, a task, or an operation procedure is conducted as described above and if the document, task, or operation procedure is changed at a descendant's site, it is necessary to change the document, task, or operation procedure at another descendant's site in the same manner and notify the operator of that fact.

Note that PTL 1 discloses a mechanism for: managing a diversion relation on a component basis; and, upon a change of the component, having a horizontal development support unit search for related components, which are descendants, and sending changed contents by e-mail to a person in charge of the related components.

### CITATION LIST

### Patent Literature

### PTL 1: Japanese Patent Application Laid-Open (Kokai) Publication No. 2007-72817

### SUMMARY OF THE INVENTION

### Problems to be Solved by the Invention

Meanwhile, when a change of a certain operation procedure conducted at a descendant's site of the operation procedure is to be reported to an operator of another descendant's site, it is necessary to make such notification at an appropriate timing. This is because, for example, if the timing to notify the operator of another descendant's site of the change of the operation procedure is too early, there is a possibility that the relevant operator may forget the change of the operation contents before conducting the changed operation, and may conduct the operation with the contents before the change.

Therefore, also from the viewpoint of preventing degradation of the operation quality and the occurrence of accidents which may be caused by conducting the operation with the content before the change, it is important to notify the operator of the change of the relevant operation procedure at an appropriate timing. However, PTL 1 does not pay any consideration at all to the timing to give such notification of the change.

The present invention was devised in consideration of the above-described circumstances and aims at proposing an operation procedure management method and system capable of effectively preventing degradation of the operation quality and the occurrence of accidents.

### Means to Solve the Problems

In order to solve the above-described problems, provided according to the present invention is an operation procedure management method conducted by an operation procedure management system including a plurality of client terminals, each of which is distributed to each of operators, and a server system for providing information regarding operation procedures to each of the operators, wherein the server system includes: a first storage apparatus storing necessary information for various kinds of processing; and a first processing unit for executing the processing by referring to the information stored in the first storage apparatus; wherein each of the client terminals includes: a second storage apparatus storing necessary information for various kinds of processing; a second processing unit for executing the processing by referring to the information stored in the second storage apparatus; and an output device for displaying the information; and wherein the operation procedure management method includes: a first step executed by the first processing unit of the server system storing diversion-related information, which is information regarding a diversion relation between the operation procedures, in the storage apparatuses and managing the diversion-related information, and upon a change of one of the operation procedures, searching for other operation procedures having the diversion relation with the changed operation procedure on the basis of the diversion-related information and transmitting changed contents as a change notification to the client terminal retained by the operator who conducts the operation procedure detected by the search; and a second step executed by the second processing unit of the client terminal, which has received the change notification, displaying a message according to the changed contents of the operation procedure on the output device at an appropriate timing.

Furthermore, provided according to the present invention is an operation procedure management system including a plurality of client terminals, each of which is distributed to each of operators, and a server system for providing information regarding operation procedures to each of the operators, wherein the server system includes: a first storage apparatus storing necessary information for various kinds of processing; and a first processing unit for executing the processing by referring to the information stored in the first storage apparatus; wherein each of the client terminals includes: a second storage apparatus storing necessary information for various kinds of processing; a second processing unit for executing the processing by referring to the information stored in the second storage apparatus; and an output device for displaying the information; wherein the first processing unit: stores diversion-related information, which is information regarding a diversion relation between the operation procedures, in the storage apparatuses and manages the diversion-related information; and upon a change of one of the operation procedures, searches for other operation procedures having the diversion relation with the changed operation procedure on the basis of the diversion-related information and transmits changed contents as a change notification to the client terminal retained by the operator who conducts the operation procedure detected by the search; and wherein upon receiving the change notification, the second processing unit displays a message according to the changed contents of the operation procedure on the output device at an appropriate timing.

This operation procedure management method and this operation procedure management system can notify an operator, who conducts other operation procedures having a diversion relation with the relevant procedure, of a change of the relevant operation procedure at an appropriate timing.

### Advantageous Effects of the Invention

The operation procedure management method and system capable of effectively preventing degradation of the operation quality and the occurrence of accidents can be implemented according to the present invention.

### BRIEF DESCRIPTION OF DRAWINGS

FIG. 1 is a block diagram illustrating an overall configuration of an operation procedure management system according to a first embodiment;

FIG. 2 is a conceptual diagram for explaining the structure of an operation procedure according to this embodiment;

FIG. 3 is a conceptual diagram for explaining a diversion relation between operation procedures;

FIG. 4 is a conceptual diagram for explaining a task addition which is one of changes of the operation procedures;

FIG. 5 is a conceptual diagram for explaining a task update which is one of changes of the operation procedures;

FIG. 6 is a conceptual diagram for explaining a task deletion which is one of changes of the operation procedures;

FIG. 7 is a conceptual diagram for explaining a notification timing to report a change of the operation procedure;

FIG. 8 is a conceptual diagram for explaining an operation procedure information table;

FIG. 9 is a conceptual diagram for explaining a task information table;

FIG. 10 is a conceptual diagram for explaining a document information table;

FIG. 11 is a conceptual diagram for explaining a diversion management table;

FIG. 12 is a conceptual diagram for explaining a change notification information table;

FIG. 13 is a schematic diagram schematically illustrating a configuration example of an operation procedure execution screen;

FIG. 14 is a schematic diagram for explaining a task operation menu;

FIG. 15 is a schematic diagram schematically illustrating a configuration example of a task addition screen;

FIG. 16 is a schematic diagram schematically illustrating a configuration example of a task update screen;

FIG. 17 is a schematic diagram schematically illustrating a configuration example of a task deletion screen;

FIG. 18 is a schematic diagram for explaining a change message;

FIG. 19 is a schematic diagram for explaining a change message;

FIG. 20 is a flowchart illustrating a processing sequence for operation procedure change accepting processing;

FIG. 21 is a flowchart illustrating a processing sequence for change notification information reception processing;

FIG. 22 is a flowchart illustrating a processing sequence for influencee operation procedure specifying processing;

FIG. 23 is a flowchart illustrating a processing sequence for change message display processing;

FIG. 24 is a ladder chart for explaining a specific example;

FIG. 25 is a block diagram illustrating an overall configuration of an operation procedure management system according to a second embodiment;

FIG. 26 is a conceptual diagram for explaining a collected data table;

FIG. 27 is a schematic diagram schematically illustrating a configuration example of a task addition screen according to the second embodiment;

FIG. 28 is a flowchart illustrating a processing sequence for change message display processing according to the second embodiment; and

FIG. 29 is a flowchart illustrating a processing sequence for message display possibility determining processing.

### DESCRIPTION OF EMBODIMENTS

An embodiment of the present invention will be explained below in detail with reference to the drawings.

### (1) First Embodiment

### (1-1) Operation Procedure Management System Configuration According to this Embodiment

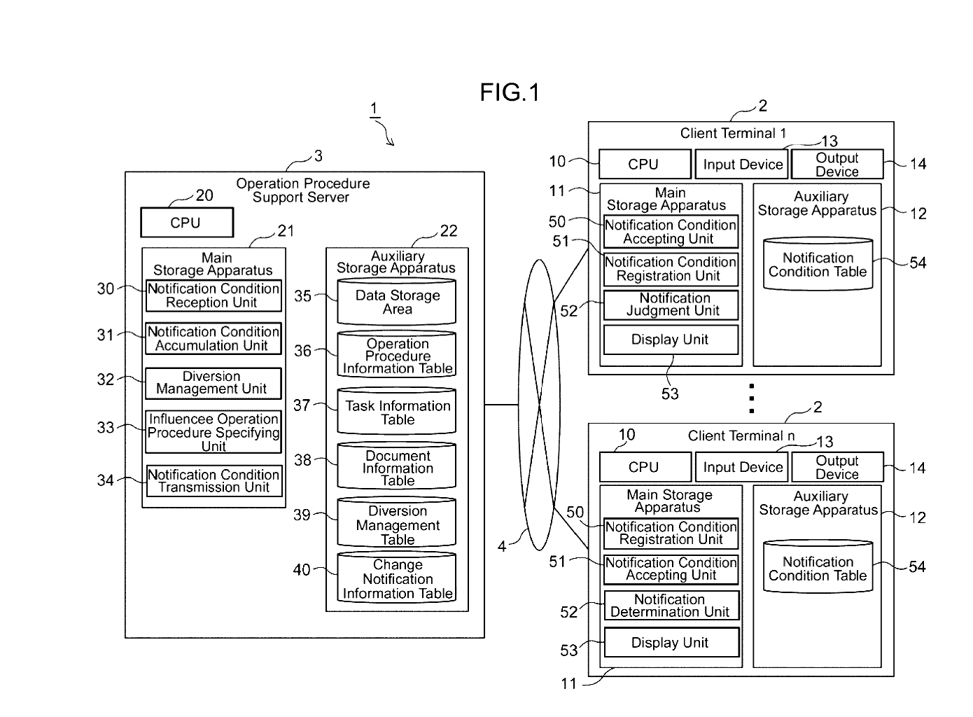

Referring to FIG. 1, the reference numeral 1 represents an operation procedure management system according to this embodiment as a whole. This operation procedure management system 1 is configured by including a plurality of client terminals 2, each of which is distributed to an operator at a site, and an operation procedure support server 3 for providing various kinds of information regarding operation procedures to each client terminal 2; and they are connected via a wireless network 4 such as a wireless LAN (Local Area Network).

The client terminal 2 is a communication terminal having a function that teaches an operator, who retains the client terminal 2, the content of operation to be conducted by the operator by displaying information regarding preset operation procedures reported by the operation procedure support server 3. The “information regarding the operation procedures” which is displayed by the client terminal 2 includes each of tasks constituting an operation procedure to be conducted by the operator, the execution order of such tasks, and specific content of these tasks.

This client terminal 2 is configured of, for example, a smartphone, a cell phone, or dedicated portable communication device and includes a CPU (Central Processing Unit) 10, a main storage apparatus 11, an auxiliary storage apparatus 12, an input device 13, and an output device 14.

The CPU 10 is a processor for controlling the operation of the entire client terminal 2. Furthermore, the main storage apparatus 11 is configured of, for example, a semiconductor memory and is used to store various kinds of programs. Various kinds of processing of the client terminal 2 as a whole is executed by the CPU 10 executing the programs stored in the main storage apparatus 11. Furthermore, the auxiliary storage apparatus 12 is configured of, for example, a nonvolatile semiconductor memory or a small-sized hard disk drive and is used to retain programs and data for a long period of time.

The input device 13 is configured of, for example, a positional input device such as a touch pad and buttons provided on the surface of the client terminal 2 and the output device 14 is configured of, for example, a liquid crystal panel. In a case of this embodiment, part of the input device 13 and part of the output device 14 constitute the touch panel.

The operation procedure support server 3 is a server system having a function that manages a plurality of operation procedures conducted respectively at different bases and supports the execution of these operation procedures; and is configured by including a CPU 20, a main storage apparatus 21, and an auxiliary storage apparatus 22.

The CPU 20 is a processor for controlling the operation of the entire operation procedure support server 3. Furthermore, the main storage apparatus 21 is configured of, for example, a semiconductor memory and is used to store various kinds of programs. Various kinds of processing of the entire operation procedure support server 3 as a whole is executed by the CPU 20 executing the programs stored in the main storage apparatus 21. Furthermore, the auxiliary storage apparatus 22 is configured of, for example, a large-capacity storage apparatus such as a hard disk drive or an SSD (Solid State Drive) and is used to retain programs and data for a long period of time.

### (1-2) Operation Procedure Change Notification Function According to this Embodiment

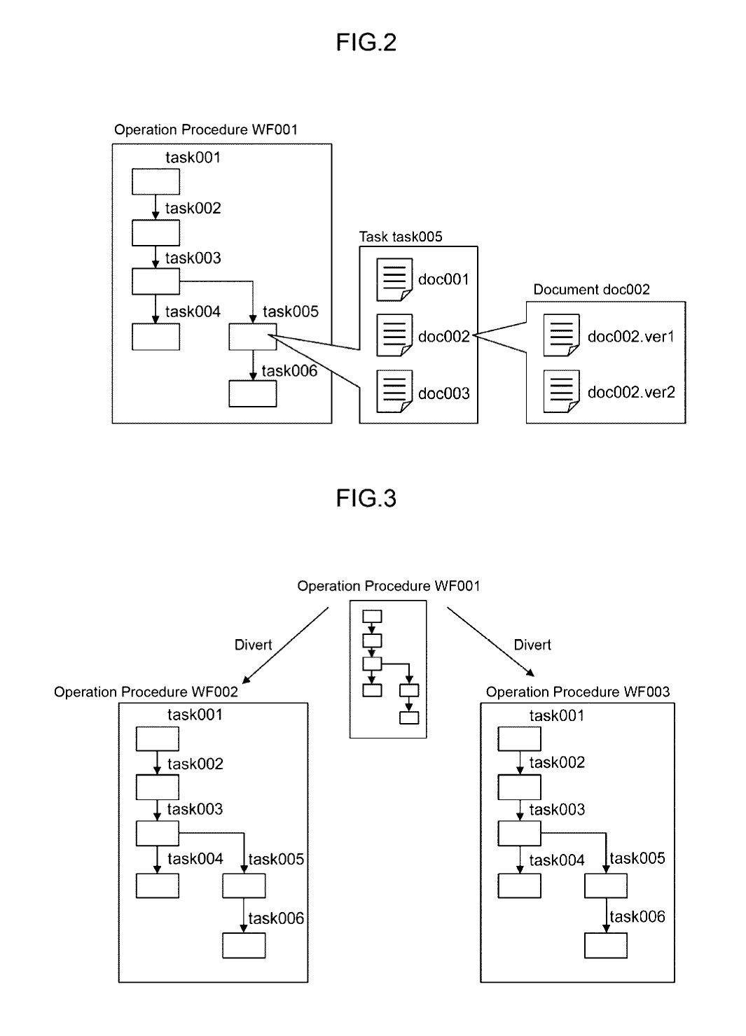

Next, an operation procedure change notification function which this operation procedure management system 1 is equipped with will be explained. Incidentally, in the following explanation, an operation procedure is composed of a plurality of series of tasks, a task is composed of one or more documents, a document is composed of a plurality of versions as illustrated in FIG. 2. The documents include, for example, documents in which operation details and inspection items are recorded, and operation manuals of an operation target, as well as photographs and inspection reports of the operation target. The “specific content of a task” displayed on the client terminal 2 as mentioned above means the content of documents constituting the relevant task.

Furthermore, the term “diversion relation between operation procedures” is used in the following explanation and this means the relation indicating whether ancestors of the operation procedures are the same or not. For example, when an operation procedure “WF001” is diverted to create two operation procedures “WF002” and “WF003” as illustrated in FIG. 3, it is considered that the operation procedure “WF002” and the operation procedure “WF003” have the “diversion relation.”

Regarding this operation procedure management system 1, when an operator who conducts an operation procedure at a site finds any inconvenience during the execution of such operation procedure, the operator can change the operation procedure by using their own client terminal 2. To “change the operation procedure” herein used means to add a new task to the relevant operation procedure or update or delete a task(s) constituting the relevant operation procedure.

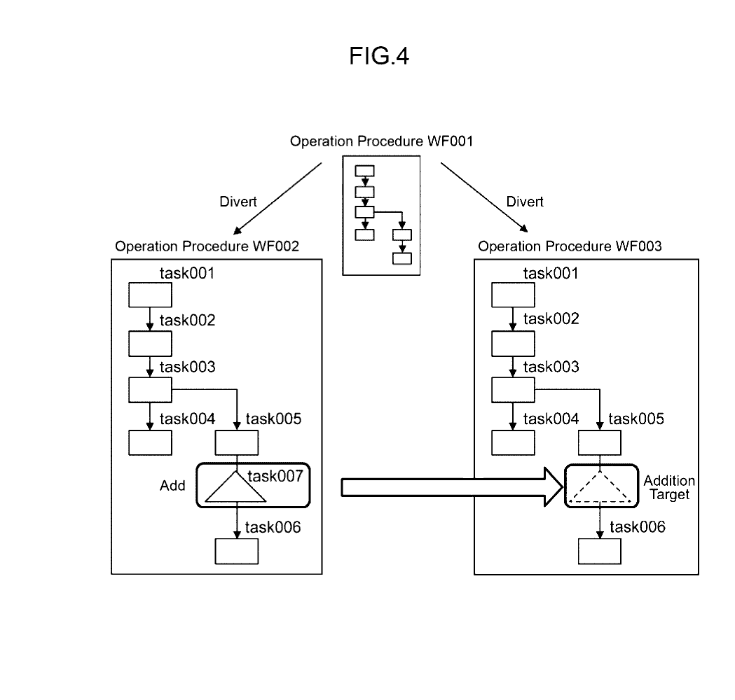

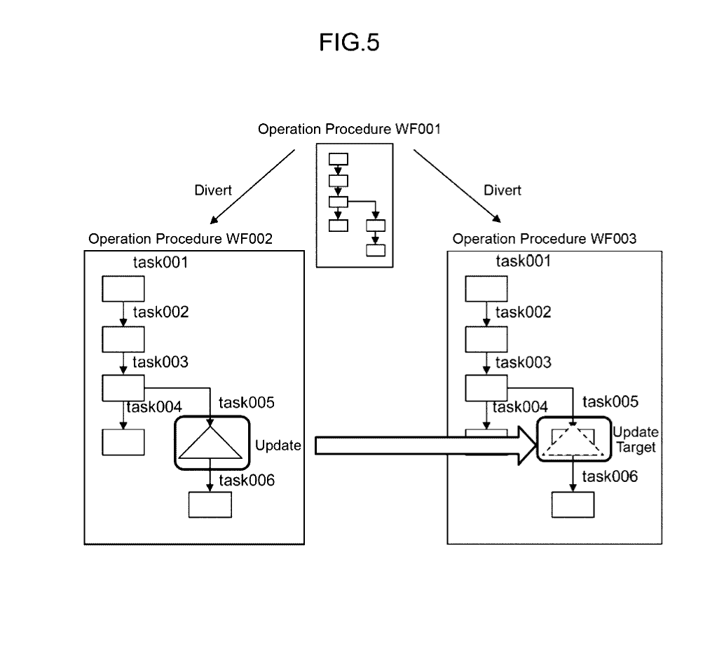

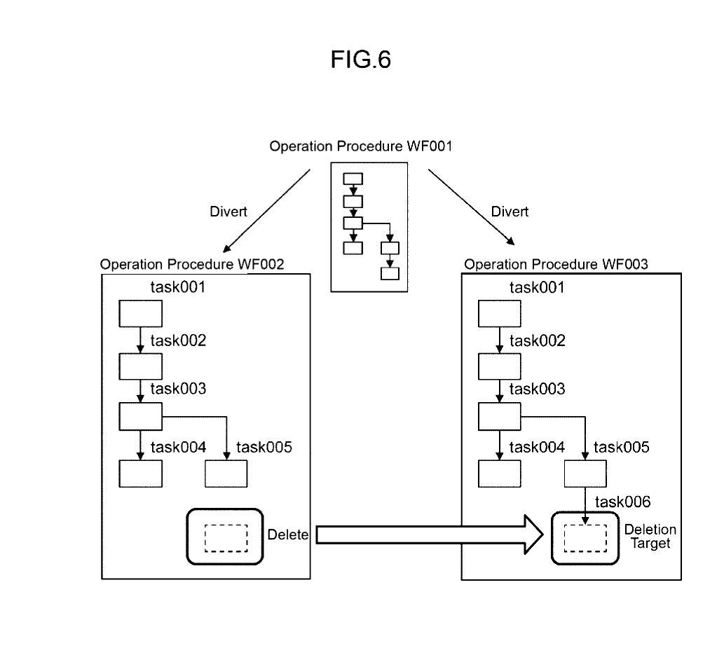

When the operator changes the operation procedure in this way, there is a possibility that, among operation procedures having the diversion relation with the relevant operation procedure (hereinafter referred to as the related operation procedures), the same inconvenience may be caused to a related operation procedure which has the same tasks constituting the related operation procedure, the same execution order of the tasks, and the same content of the individual tasks (hereinafter referred to as the task configuration); and, therefore, it necessary to inform an operator who conducts that related operation procedure that the relevant related operation procedure should be changed in the same manner as illustrated in FIG. 4 to FIG. 6. Incidentally, FIG. 4 illustrates a case where a task is added; FIG. 5 illustrates a case where a task is updated; and FIG. 6 illustrates a case where a task is deleted.

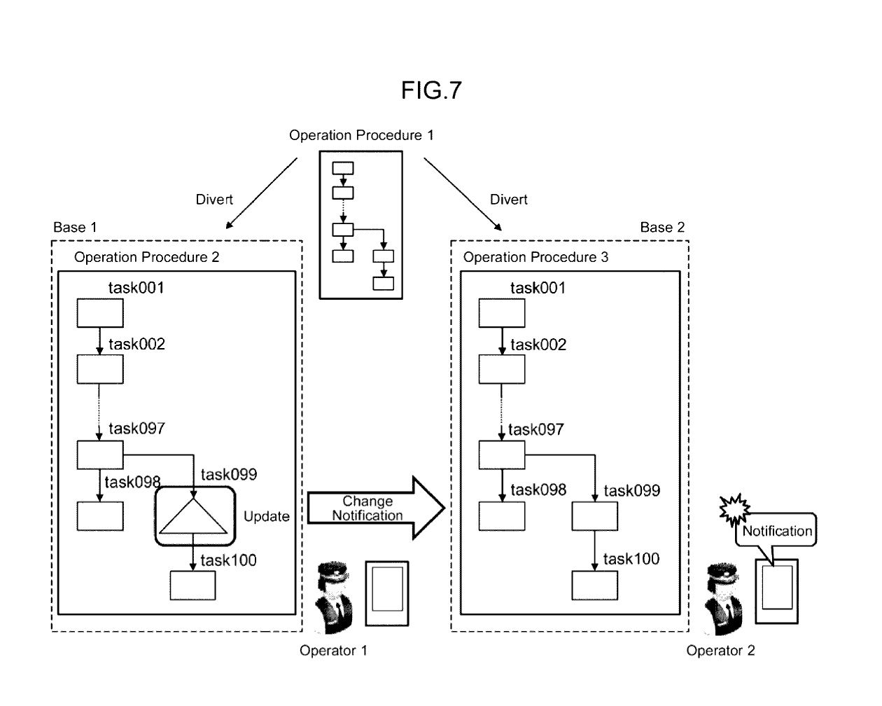

In this case, it is necessary to perform such notification at an appropriate timing. For example, let us assume a case as illustrated in FIG. 7 where operation procedure 1 composed of 100 tasks from “task1” to “task100” are diverted to create operation procedure 2 and operation procedure 3, operator A conducts the operation procedure 2 at base 1, and operator B conducts the operation procedure 3 at base 2. Under this circumstance, operator A changes the operation procedure 2 to update the content of a task called “task99.”

In this case, it is desirable from the viewpoint of prevention of quality degradation and prevention of accidents of the operation procedure 3 conducted by operator B that operator B is informed of the change of the operation procedure 2 by operator A. However, for example, even if operator B receives this notification during execution of a task called “task2,” the task “task99” will be conducted much later and, therefore, there is a possibility that operator B might forget regarding the update of the task “task99” before actually executing the task “task99.” Particularly, the operator who is familiar with the operation may possibly proceed with the operation on the basis of their past experiences, so there is a possibility that the operator might conduct the task “task 99” with the content before the update.

Therefore, when an operation procedure is changed, it is important to notify the operator who conducts its related operation procedure of the change of the operation procedure at an appropriate timing.

Accordingly, this operation procedure management system 1 is equipped with an operation procedure change notification function that notifies, when a certain operation procedure is changed, an operator who conducts a related operation procedure having the same task configuration, from among its related operation procedures, of the change of the operation procedure (to add, update, or delete the relevant task) at an appropriate timing.

Practically, regarding this operation procedure management system 1, when an operator changes an operation procedure by operating the client terminal 2, that operator also designates a condition to notify an operator, who conducts the relevant related operation procedure, of such change (hereinafter referred to as the notification condition). Specifically speaking, the operator designates, as such notification condition, the timing to notify the operator, who conducts the related operation procedure, of the change of the operation procedure which they have performed. Then, after the operator performs the operation to change the operation procedure in this manner, its changed contents and the notification condition are transmitted as change notification information from the client terminal 2 to the operation procedure support server 3.

The operation procedure support server 3 manages the diversion relation between operation procedures; and when the above-described change notification information is transmitted from the client terminal 2, the operation procedure support server 3 detects related operation procedures having the same task configuration as that of the changed operation procedure from among related operation procedures having the diversion relation with the changed operation procedure. Then, the operation procedure support server 3 transmits an update notification, whose content is the same as that of the change notification information transmitted from the client terminal 2, to a client terminal 2 of each operator who conducts each of the detected related operation procedures.

The client terminal 2 which has received this change notification checks the state of progress of the current operation procedure (the related operation procedure); and if the timing which matches the notification condition designated by the change notification has not yet come, the client terminal 2 displays a message indicating that the operation procedure should be updated (hereinafter referred to as the change message), at the timing matching the relevant notification condition, and then reflects the update of the operation procedure in the operation procedure whose information it display (the related operation procedure).

Furthermore, if the timing which matches the notification condition designated by the change notification has already passed, the client terminal 2 displays a message indicating that the operation procedure should be updated, and a message to prompt the operator to judge whether the change of the operation procedure should be actually applied or not; and if the operator operates to change the operation procedure, the client terminal 2 reflects such change of the operation procedure in the operation procedure whose information it displays (the related operation procedure).

The main storage apparatus 21 for the operation procedure support server 3 stores, as means for implementing the above-described operation procedure change notification function, a notification condition reception unit 30, a notification condition accumulation unit 31, a diversion management unit 32, an influencee operation procedure specifying unit 33, and a notification condition transmission unit 34 as illustrated in FIG. 1. Furthermore, the auxiliary storage apparatus 22 for the operation procedure support server 3: is provided with a data storage area 35 which stores each of documents constituting tasks; and stores an operation procedure information table 36, a task information table 37, a document information table 38, a diversion management table 39, and a change notification information table 40.

The notification condition reception unit 30 is a program having a function that receives the aforementioned change notification information transmitted from the client terminal 2; and the notification condition accumulation unit 31 is a program having a function that registers the received change notification information in the change notification information table 40.

Furthermore, the diversion management unit 32 is a program having a function that manages the diversion relation between operation procedures; and the influencee operation procedure specifying unit 33 is a program having a function that identifies a related operation procedure(s) having the same task configuration as that of the changed operation procedure from among the related operation procedures of the changed operation procedure by referring to the diversion relation between operation procedures managed by the diversion management unit 32.

Furthermore, the notification condition transmission unit 34 is a program having a function that transmits the aforementioned change notification to the client terminal 2 of the operator who conducts the related operation procedure identified by the influencee operation procedure specifying unit 33.

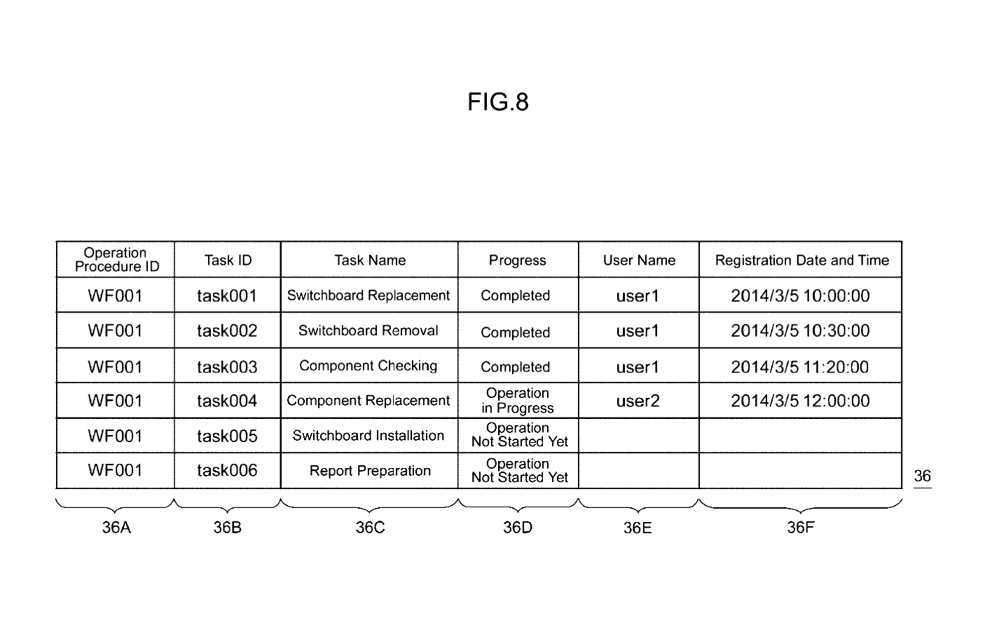

The operation procedure information table 36 is a table used to manage each operation procedure and is configured by including an operation procedure ID column 36A, a task ID column 36B, a task name column 36C, a progress column 36D, a user name column 36E, and a registration date and time column 36F as illustrated in FIG. 8.

Then, the operation procedure ID column 36A stores a unique identifier (operation procedure ID) of the relevant operation procedure, which is assigned to each of individual operation procedures; and the task ID column 36B stores a unique identifier (task ID) of the relevant task, which is assigned to each of tasks constituting the corresponding operation procedure.

Furthermore, the task name column 36C stores a label (task name) assigned by the user to the corresponding task; and the progress column 36D stores progress information (operation not started yet, operation in progress, or completed) representing the state of progress of the corresponding task, which is reported from the relevant client terminal 2 by the operator who conducts the corresponding operation procedure by operating the client terminal 2.

Furthermore, the user name column 36E stores an identifier (user name) of an operator who has conducted or is conducting the corresponding task; and the registration date and time column 36F stores a date and time when the execution of the corresponding task was started.

Therefore, an example of FIG. 8 shows that the operation procedure “WF001” is composed of six tasks (“task001” to “task006”) to which task names “switchboard replacement,” “switchboard removal,” “component inspection,” “component replacement,” “switchboard installation,” and “report preparation” are assigned respectively. Then, the example of FIG. 8 shows that among these tasks, operations of three tasks called “switchboard replacement,” “switchboard removal,” and “component inspection” (“task001” to “task003”) were started by a user called “user1” at “2014/3/5 10:00:00,” “2014/3/5 10:30:00,” and “2014/3/5 11:20:00” respectively and have already been “Completed,” the task called “component inspection” (task004″) was started by a user called “user2” at “2014/3/5 12:00:00” and is currently in a state of “Operation in Progress,” and the tasks called “switchboard installation” and “report preparation” (“task005” and “task006”) are in a state of “Operation Not Started Yet.”

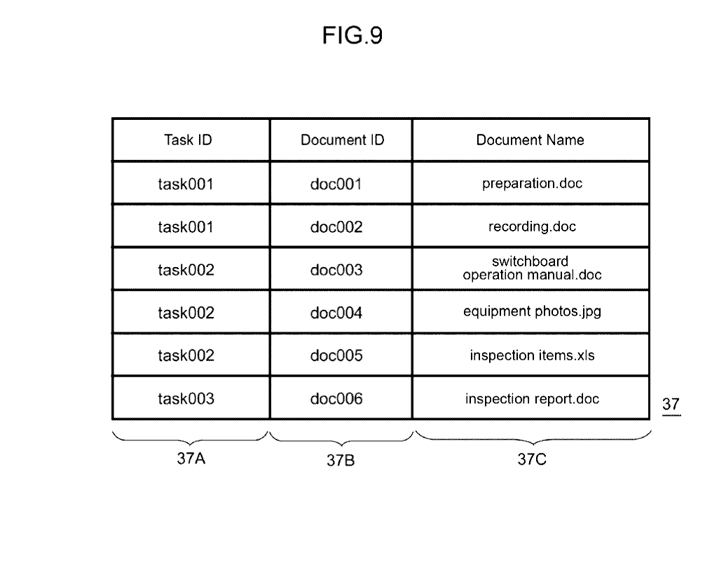

The task information table 37 is a table used to manage tasks constituting operation procedures and is composed of a task ID column 37A, a document ID column 37B, and a document name column 37C as illustrated in FIG. 9.

Then, the task ID column 37A stores a task ID assigned to each task; and the document ID column 37B stores identifiers (document IDs) assigned to documents constituting the corresponding task. Furthermore, the document name column 37C stores a label (document name) assigned to the corresponding document.

Therefore, an example of FIG. 9 shows that a task called “task001” is composed of a document with a document name “preparation.doc” and a document ID “doc001” and a document with a document name “recording.doc” and a document ID “doc002”; and a task called “task002” is composed of a document with a document name “switchboard operation manual.doc” and a document ID “doc003,” a document (photo) with a document name “equipment photos.jpg” and a document ID “doc004,” and a document with a document name “inspection items.xls” and a document ID “doc005.”

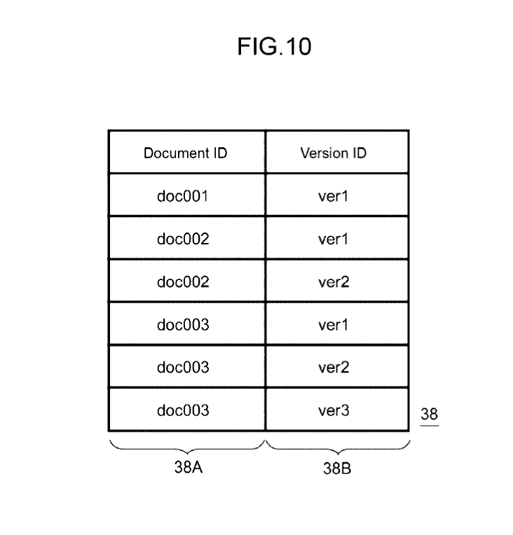

The document information table 38 is a table used to manage each document and is composed of a document ID column 38A and a version ID column 38B as illustrated in FIG. 10. Then, the document ID column 38A stores all document IDs assigned to individual documents; and the version ID column 38B stores identifiers of versions (version IDs) existing for the corresponding document.

Therefore, an example of FIG. 10 shows that only a version “ver1” exists for the document with the document ID “doc001,” two versions “ver1” and “ver2” exist for the document with the document ID “doc002,” and three versions “ver1,” “ver2,” and “ver3” exist for the document with the document ID “doc003.”

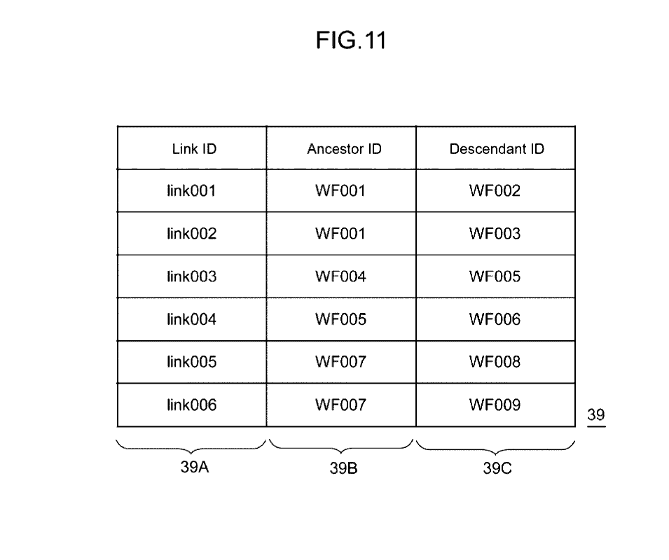

The diversion management table 39 is a table used to retain and manage diversion-related information which is information indicating the diversion relation between operation procedures; and is composed of a link ID column 39A, an ancestor ID column 39B, and a descendant ID column 39C as illustrated in FIG. 11. Then, the link ID column 39A stores an identifier (link ID) assigned to an individual diversion relation, the ancestor ID column 39B stores an operation procedure ID of an ancestor's operation procedure, and the descendant ID column 39B stores an operation procedure ID of a descendant's operation procedure.

Therefore, the example of FIG. 11 shows that, for example, each of the operation procedures “WF002” and “WF003” are created by diverting the operation procedure “WF001,” a link ID “link001” is assigned to the diversion relation between the two operation procedures “WF001” and “WF002,” and a link ID “link002” is assigned to the diversion relation between the two operation procedures “WF001” and “WF003.”

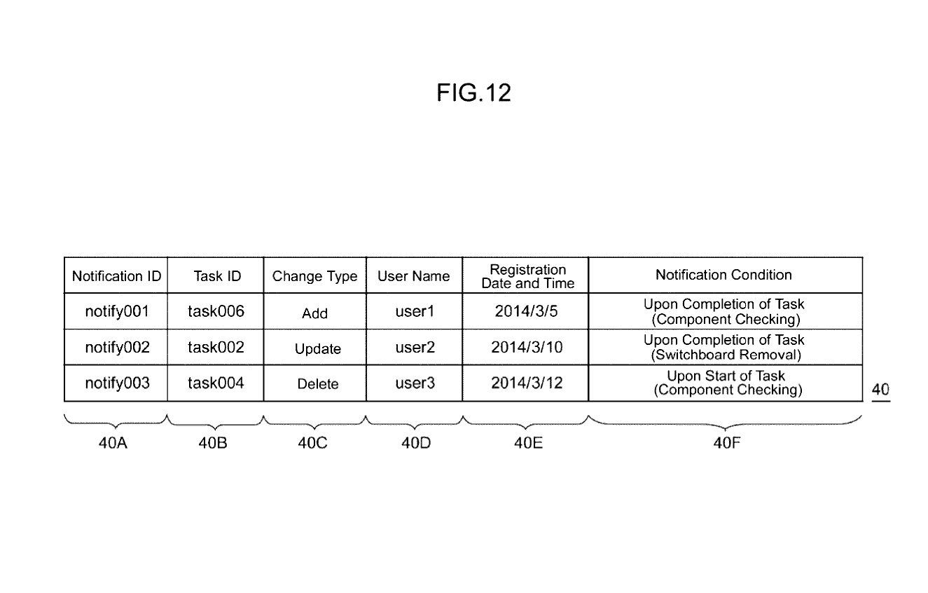

The change notification information table 40 is a table used to retain the change notification information transmitted from the client terminal 2 and is created for each operation procedure registered in the operation procedure support server 3. This change notification information table 40 is composed of a notification ID column 40A, a task ID column 40B, a change type column 40C, a user name column 40D, a registration date and time column 40E, and a notification condition column 40F as illustrated in FIG. 12.

Then, the notification ID column 40A stores a unique identifier (notification ID) of change notification information assigned to the change notification information received by the operation procedure support server 3; and the task ID column 40B stores a task ID of a target task to be changed.

Furthermore, the change type column 40C stores a change type (addition, update, or deletion) of the corresponding task; and the user name column 40D stores a user name of an operator who performed the change of the relevant task (the change of the operation procedure). Furthermore, the registration date and time column 40E stores a date and time when the operation procedure support server 3 received the corresponding change notification information; and the notification condition column 40F stores a notification condition included in the relevant change notification information.

Therefore, an example of FIG. 12 shows that change notification information which the operation procedure support server 3 received on “2014/3/5” and to which a notification ID “notify001” is assigned is a change of the operation procedure to “add” a task “task006” performed by an operator whose user name is “user1” and its notification condition is “upon completion of task (component inspection).”

Incidentally, among these pieces of information registered in the change notification information table 40, information registered in the task ID column 40B, the change type column 40C, the user name column 40D, and the notification condition column 40F is acquired from the corresponding change notification information. Therefore, the change notification information transmitted from the client terminal 2 to the operation procedure support server 3 includes at least these pieces of information.

Meanwhile, the main storage apparatus 11 for the client terminal 2 stores a notification condition accepting unit 50, a notification condition registration unit 51, a notification determination unit 52, and a display unit 53 and the auxiliary storage apparatus 12 for the client terminal 2 stores a notification condition table 54 as illustrated in FIG. 1.

The notification condition accepting unit 50 is a program having a function that receives the change notification transmitted from the operation procedure support server 3; and the notification condition registration unit 51 is a program having a function that registers the change notification, which is received by the notification condition accepting unit 50, in the notification condition table 54.

Furthermore, the notification determination unit 52 is a program having a function that determines whether a change message should be displayed on the output device 14 or not, on the basis of the change notification registered in the notification condition table 54. Furthermore, the display unit 53 is a program having a function that displays various kinds of screens and the above-mentioned change message on the output device 14.

The notification condition table 54 is a table used to retain the change notification which the client terminal 2 has received from the operation procedure support server 3. Since the notification condition table 54 has almost the same configuration as that of the change notification information table 40 described above with reference to FIG. 12, an explanation regarding it has been omitted here.

### (1-3) Configurations of Various Kinds of Screens

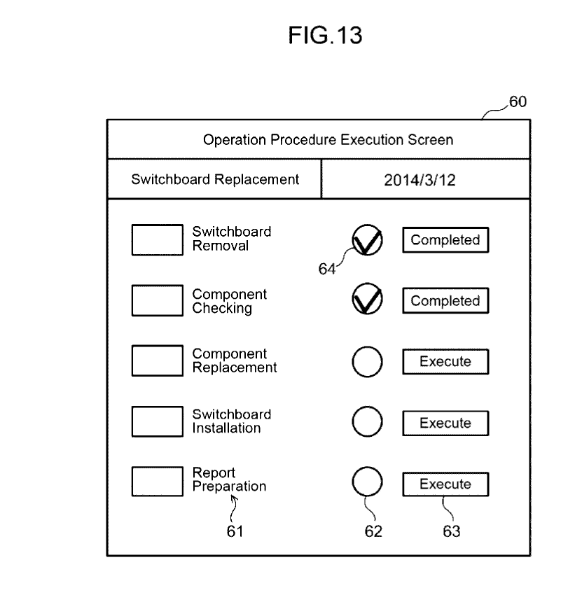

FIG. 13 illustrates a screen configuration of an operation procedure execution screen 60 displayed on the client terminal when the operator conducts an operation procedure. The operation procedure execution screen 60 is a screen to display, for the operator, the execution order of respective tasks constituting the operation procedure to be then conducted by the operator and specific content of each task, and for the operator to enter the state of progress of these tasks.

Practically, on the operation procedure execution screen 60, task names 61 of the respective tasks constituting the relevant operation procedure are listed and arranged in the order of the tasks to be executed. Furthermore, check boxes 62 and execution buttons 63 associated with these task names 61 respectively are also displayed on the operation procedure execution screen 60.

Then, when the operator conducts an operation procedure, they will execute tasks whose task names 61 are listed on the operation procedure execution screen 60, in the order listed on the relevant operation procedure execution screen 60; and when doing so, the operator taps the execution button 63 before starting the relevant task. As a result, a character string displayed on the execution button 63 is updated from “Execute” to “Completed.” Incidentally, when the execution button 63 is tapped in this way, the client terminal 2 notifies the operation procedure support server 3 to that effect and the progress information stored in the progress column 36D (FIG. 8) of the operation procedure information table 36 (FIG. 8) is updated on the basis of this from “Operation Not Started Yet” to “Operation in Progress.”

Furthermore, the operator can display documents constituting the relevant task on the client terminal 2 by tapping a row corresponding to that task in this state. Accordingly, the operator can conduct the task as specified while referring to the documents displayed on the client terminal 2.

Then, when the operator completes the task, they tap the execution button 63 (the execution button 63 on which the displayed character string has changed to “Completed”) corresponding to the task. As a result, a check mark 64 is displayed in the check box 62 associated with that task. Furthermore, when this happens, the completion of the task is reported from the client terminal 2 to the operation procedure support server 3 and, on the basis of this notification, the progress information stored in the progress column 36D of the operation procedure information table 36 is updated from “Operation in Progress” to “Completed.”

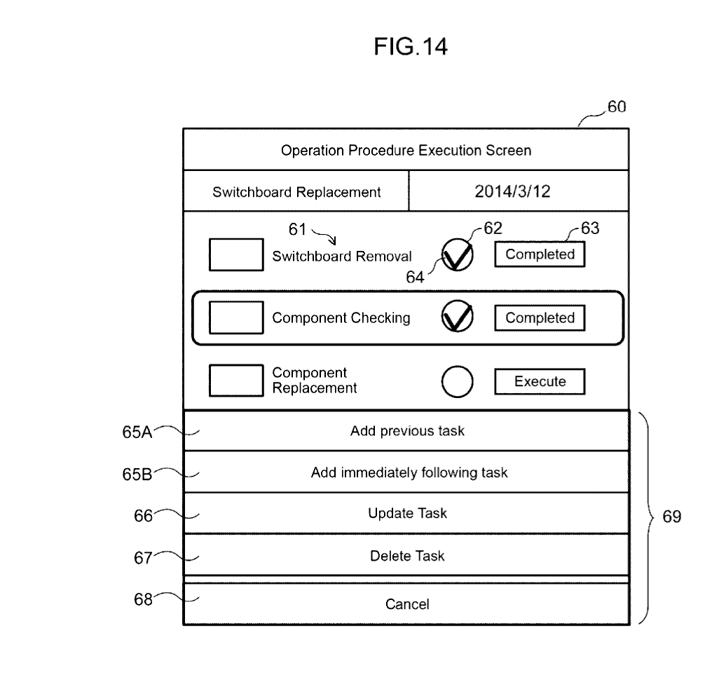

On the other hand, when the operation procedure which is being executed is to be changed (by adding, updating, or deleting a task) on the operation procedure execution screen 60, the relevant task is selected by, for example, long tapping of a row corresponding to the desired task on the relevant operation procedure execution screen 60. As a result, it is possible to display a task operation menu 69 composed of a previous task addition button 65A, an immediately following task addition button 65B, a task update button 66, a task deletion button 67, and a cancel button 68 as illustrated in FIG. 14. Incidentally, a row corresponding to the then selected task (hereinafter referred to as the selected task) is surrounded by a frame or is highlight-displayed.

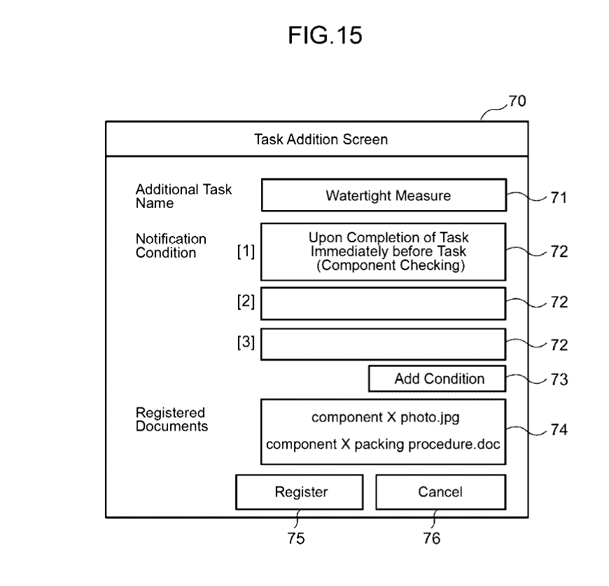

Then, the operator can switch the display screen of the client terminal 2 to a task addition screen 70 illustrated in FIG. 15 by tapping the previous task addition button 65A or the immediately following task addition button 65B on such task operation menu 69.

The task addition screen 70 is a screen to set a change of the operation procedure to add a new task immediately before (when the previous task addition button 65A is tapped) or immediately after (when the immediately following task addition button 65A is tapped) of the task selected as described above on the operation procedure execution screen 60 (hereinafter referred to as the selected task) and is configured by including an additional task name field 71, a plurality of notification condition fields 72, a condition addition button 73, a registered document field 74, a register button 75, and a cancel button 76.

The additional task name field 71 is a text box to set a task name of the task to be added immediately before or immediately after the task selected on the operation procedure execution screen 60 and the operator can enter a desired task name.

Furthermore, the notification condition field 72 is a text box to set a condition (notification condition) to display the aforementioned change message on the client terminal 2 of the operator who conducts the related operation procedure. Incidentally, the notification condition may be entered by the operator by entering the notification condition into the notification condition field 72 by using a character string or a timing when the addition of such task can be reported (immediately after the completion of the selected task) may be displayed as a default value.

Not only one notification condition, but also a plurality of notification conditions can be set by setting a notification condition to each notification condition field 72 of the task addition screen 70. In this case, when all the set notification conditions are satisfied, a change message described later is displayed on the client terminal 2. Furthermore, with the task addition screen 70, an additional notification condition field 72 can be displayed by tapping the condition addition button 73, thereby making it possible to set an arbitrary number of notification conditions.

The registered document field 74 is a field to set a document(s) constituting the task to be added at that time. The operator can enter a document name of a desired document from among documents registered in the operation procedure support server 3 in advance so that the document can be set as a document constituting the relevant task.

Incidentally, not only one document name, but also a plurality of document names can be entered to the registered document field 74. In this case, these plural documents constitute the relevant task. Furthermore, regarding the document(s) to be set to the registered document field 74, a pull-down menu in which document names of all the documents already registered in the operation procedure support server 3 are listed may be displayed so that the operator can select the document(s) from the pull-down menu.

Then, regarding the task addition screen 70, it is possible to perform a change to add the relevant task to the operation procedure which is currently being executed, by setting the task name of the task to be added, the notification condition, and the document(s) (registered document(s)) constituting the relevant task as described above and then tapping the register button 75. When this happens, the content which is set on the task addition screen 70 is transmitted as the change notification information from the client terminal 2 to the operation procedure support server 3 as described earlier.

Furthermore, by tapping the cancel button 76 on the task addition screen 70, the relevant task addition screen 70 can be closed to return to the operation procedure execution screen 60 (FIG. 13) without transmitting the content which is then set on the task addition screen 70, as the change notification information to the operation procedure support server 3.

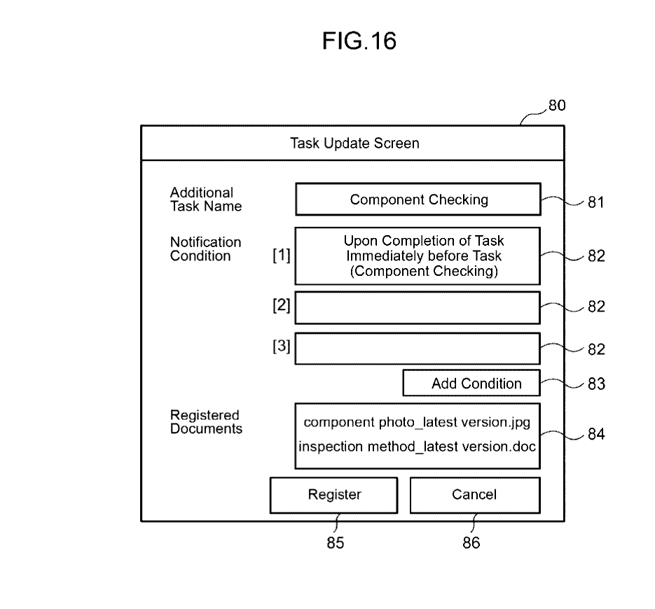

Meanwhile, the operator can switch the display screen of the client terminal 2 to a task update screen 80 illustrated in FIG. 16 by tapping the task update button 66 on the task operation menu 69 described earlier with reference to FIG. 14.

The task update screen 80 is a screen to set settings to update the setting content of the task (selected task) selected on the operation procedure execution screen 60 and is configured by including an additional task name field 81, a plurality of notification condition fields 82, a condition addition button 83, a registered document field 84, a register button 85, and a cancel button 86.

Functions and configurations of the additional task name field 81, the notification condition fields 82, the condition addition button 83, and the registered document field 84 are the same as those of the corresponding parts of the task addition screen 70 described above with reference to FIG. 15. However, regarding the task update screen 80, a task name, notification conditions, and registered document(s) which are then set with respect to the selected task are stored as defaults in the additional task name field 81, the notification condition field 82, and the registered document field 84, respectively.

Then, regarding the task update screen 80, the operator can freely update the task name of the selected task which is stored in the additional task name field 81 of the task update screen 80, the notification condition(s) which is set in the notification condition field 82, and the registered document(s) which is set in the registered document field 84.

Therefore, the operator can set the relevant change by updating desired items of the task name, the notification condition(s), and the registered document(s) of the selected task on the task update screen 80 to desired content and then tapping the register button 85. In this case, the content which is set on the task update screen 80 is transmitted as the change notification information from the client terminal 2 to the operation procedure support server 3.

Furthermore, the operator can close the relevant task update screen 80 to make the display screen of the client terminal 2 return to the operation procedure execution screen 60 (FIG. 13) by tapping the cancel button 86 without transmitting the content which is then set on the task update screen 80, as the change notification information to the operation procedure support server 3.

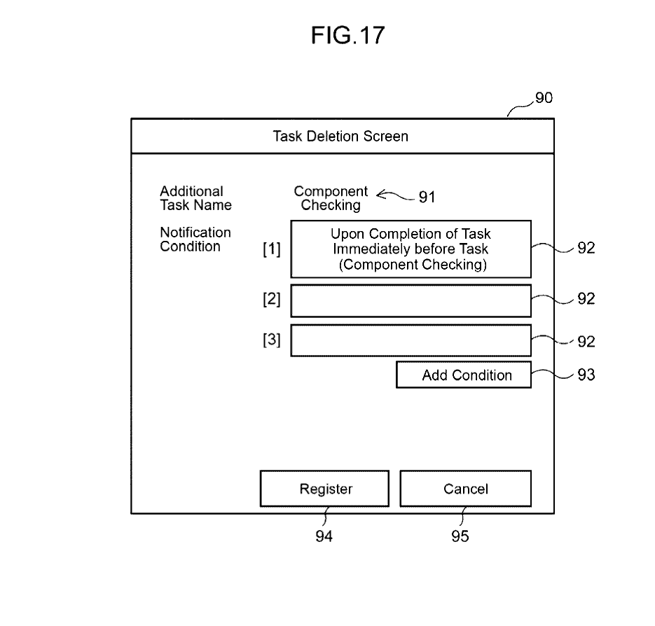

Meanwhile, the operator can switch the display screen of the client terminal 2 to a task deletion screen 90 illustrated on FIG. 17 by tapping the task deletion button 67 on the task operation menu 69 described earlier with reference to FIG. 14.

The task deletion screen 90 is a screen to set settings to delete a task selected on the operation procedure execution screen 60 (selected task) from the operation procedure which is currently being executed. On this task deletion screen 90, a task name 91 of the selected task which is a deletion target is displayed in an unchangeable state.

Furthermore, a plurality of notification condition fields 92, a condition addition button 93, a register button 94, and a cancel button 95 are displayed on the task deletion screen 90. Functions and configurations of the notification condition fields 92 and the condition addition button 93 are the same as those of the corresponding parts of the task addition screen 70 described above with reference to FIG. 15.

Therefore, the operator can set the relevant change by setting desired notification conditions to the notification condition fields 92 on the task deletion screen 90 and then tapping the register button 94. In this case, the content which is set on the task deletion screen 90 is transmitted as the change notification information from the client terminal 2 to the operation procedure support server 3.

Furthermore, the operator can close the relevant task deletion screen 90 to make the display screen of the client terminal 2 return to the aforementioned operation procedure execution screen 60 (FIG. 13) by tapping the cancel button 95 without transmitting the content which is then set on the task deletion screen 90, as the change notification information to the operation procedure support server 3.

Furthermore, the operator can close the task operation menu 69 by tapping the cancel button 68 on the task operation menu 69 described earlier with reference to FIG. 14 without setting settings to add, change, or delete a task.

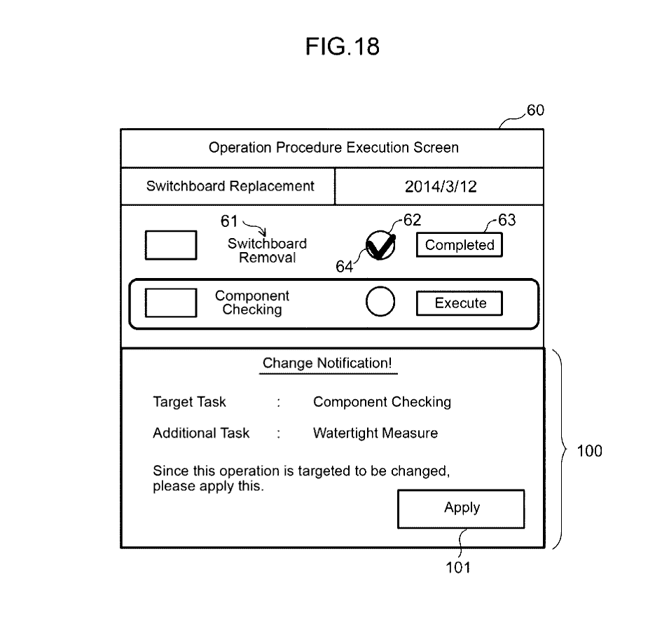

Meanwhile, FIG. 18 illustrates a display example of the operation procedure execution screen 60 displayed on the client terminal which has received the change notification from the operation procedure support server 3 when the timing which matches the notification condition included in the relevant change notification comes.

On this operation procedure execution screen 60, the task name of a target task is surrounded by a frame or is highlight-displayed and a change message display area 100 is also displayed at the bottom of the screen. Then, a change message composed of a character string indicating “Change Notification!” to draw the operator's attention, a character string indicating a target task to be changed, and a character string with content to prompt application of the change is displayed in the change message display area 100 and an apply button 101 is further displayed.

Then, the operator can make the client terminal 2 execute the change of the operation procedure in accordance with such change message by tapping the apply button 101 displayed in the change message display area 100. Specifically speaking, the displayed content of the operation procedure execution screen 60 is changed in accordance with the change notification.

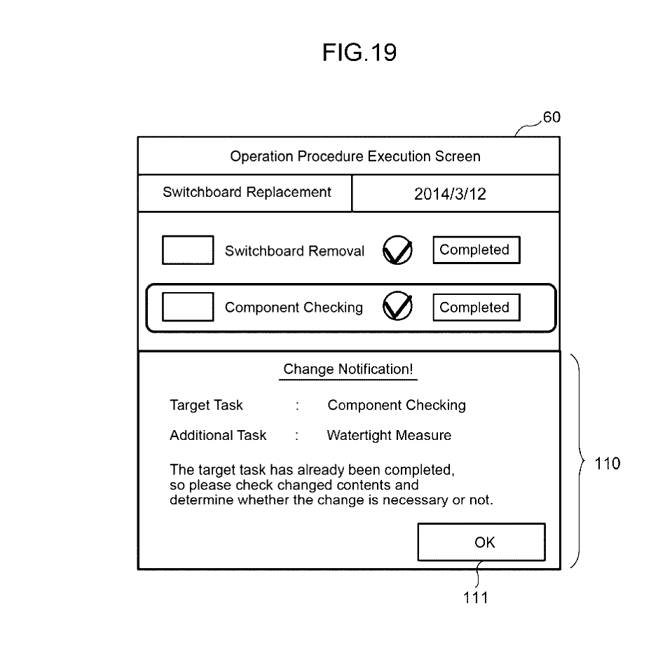

Furthermore, FIG. 19 illustrates a display example of the operation procedure execution screen 60 displayed in a case where a target task has already been completed when the client terminal 2 to receive a change notification from the operation procedure support server 3 receives the relevant change notification.

On this operation procedure execution screen 60, the task name of the target task is surrounded by a frame and a change message display area 110 is displayed at the bottom of the screen in the same manner as in the case of FIG. 18. Then, a change message composed of a character string indicating “Change Notification!” to draw the operator's attention, a character string indicating the target task to be changed, and a character string with content to prompt the operator to judge whether to apply the change or not is displayed in the change message display area 110 and an OK button 111 is further displayed.

Then, the operator can delete the relevant change message display area 110 from the operation procedure execution screen 60 by tapping the OK button 111 displayed in the change message display area 110. Therefore, the operator then judges whether it is necessary to change the operation procedure or not, by discussing it with, for example, their superior; and if it is determined that it is necessary to change the operation procedure, the operator will change the relevant task manually by operating the client terminal 2.

### (1-4) Various Kinds of Processing Regarding Operation Procedure Change Notification Function

Next, specific processing content of various kinds of processing executed by the client terminal 2 and the operation procedure support server 3 in relation to the operation procedure change notification function according to this embodiment will be explained. Incidentally, in the following explanation, a processing subject of the various kinds of processing will be described as a program (“XXX unit”); however, practically, it is a matter of course that the CPU 10 for the client terminal 2 or the CPU 20 for the operation procedure support server 3 executes the relevant processing according to that program.

### (1-4-1) Operation Procedure Change Accepting Processing

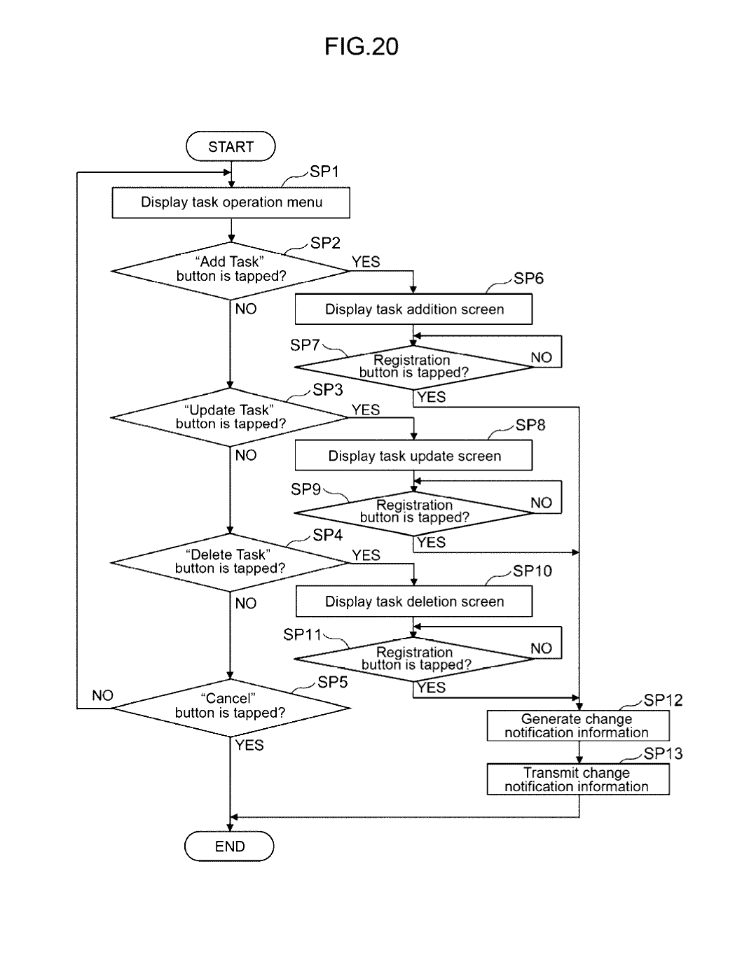

FIG. 20 illustrates a processing sequence for operation procedure change accepting processing executed by the notification condition registration unit 51 for the client terminal 2. When one task is selected by a long tap operation on the operation procedure execution screen 60 (FIG. 13), the notification condition registration unit 51 starts this processing and firstly issues an instruction to the display unit 53 (FIG. 1) to display the task operation menu 69 (FIG. 14) on the operation procedure execution screen 60 (SP).

Subsequently, the notification condition registration unit 51 waits for any one button of the task addition button 65, the task update button 66, the task deletion button 67, and the cancel button 68 on the task operation menu 69 to be tapped (SP1 to SP5).

Then, when the cancel button 68 is tapped, the notification condition registration unit 51 terminates this operation procedure change accepting processing.

On the other hand, when the task addition button 65 is tapped, the notification condition registration unit 51 issues an instruction to the display unit 53 to display the task addition screen 70 described earlier with reference to FIG. 15 (SP6). Subsequently, after the task name, the notification condition, and the registered document(s) of the task to be then added are set on this task addition screen 70, the notification condition registration unit 51 waits for the register button 75 (FIG. 15) to be tapped (SP7); and then when the register button 75 is eventually tapped (SP7: YES), the notification condition registration unit 51 proceeds to step SP12.

Furthermore, when the task update button 66 is tapped, the notification condition registration unit 51 issues an instruction to the display unit 53 to display the task update screen 80 described earlier with reference to FIG. 16 (SP8). Subsequently, when some or all of the task name, the notification condition, and the registered document(s) of the task to be then updated are updated on this task update screen 80, the notification condition registration unit 51 waits for the register button 85 (FIG. 16) to be tapped (SP9); then when the register button 85 is eventually tapped (SP9: YES), the notification condition registration unit 51 proceeds to step SP12.

Furthermore, when the task deletion button 67 is tapped, the notification condition registration unit 51 issues an instruction to the display unit 53 to display the task deletion screen 90 described earlier with reference to FIG. 17 (SP10). Subsequently, after the notification condition is set on this task deletion screen 90, the notification condition registration unit 51 waits for the register button 94 to be tapped (SP11) then when the register button 94 is eventually tapped (SP11: YES), the notification condition registration unit 51 proceeds to step SP12.

Then, the notification condition registration unit 51 generates change notification information according to the content set on the task addition screen 70, the task update screen 80, or the task deletion screen 90 (SP12); and after transmitting the generated change notification information to the operation procedure support server 3 (SP13), the notification condition registration unit 51 terminates this operation procedure change accepting processing.

### (1-4-2) Change Notification Information Reception Processing

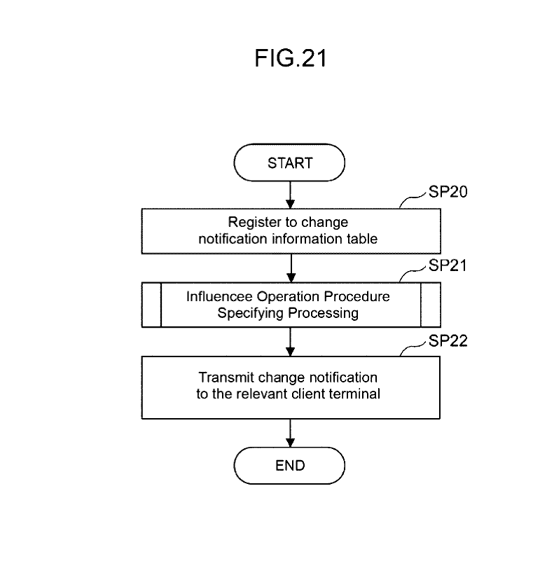

Meanwhile, FIG. 21 illustrates a processing sequence for change notification information reception processing executed by the operation procedure support server 3 which has received the change notification information from the client terminal 2.

After the notification condition reception unit receives such the change notification information, the operation procedure support server 3 starts this change notification information reception processing; and firstly the change notification information received by the notification condition reception unit 30 (FIG. 1) is registered in the change notification information table 40 (FIG. 12) by the notification condition accumulation unit 31 (SP20).

Subsequently, the influencee operation procedure specifying unit 33 (FIG. 1) identifies operation procedures influenced by the change of the operation procedure recognized by this change notification information (related operation procedures of the changed operation procedure) and creates an influencee operation procedure list in which only these identified related operation procedures are listed (SP21).

Then, the notification condition transmission unit 34 (FIG. 1) transmits a change notification to each of client terminals 2 retained by operators who conduct the respective related operation procedures listed in the influencee operation procedure list (SP22). Accordingly, the change notification information reception processing by the operation procedure support server 3 is terminated.

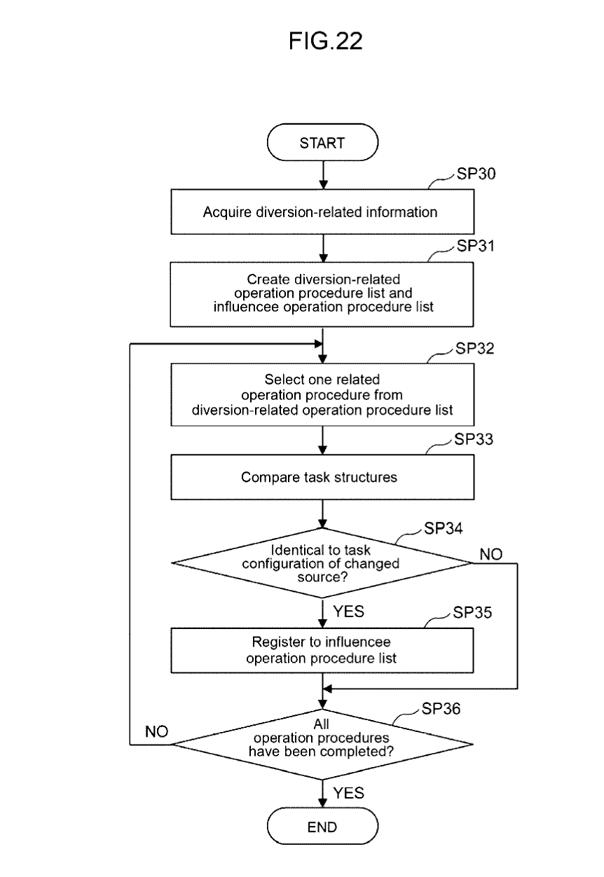

Now, FIG. 22 illustrates the influencee operation procedure specifying processing executed by the influencee operation procedure specifying unit 33 in step SP21 of such change notification information reception processing. The influencee operation procedure specifying unit 333 identifies the related operation procedures of the operation procedure changed by the processing sequence illustrated in this FIG. 22.

Practically, the influencee operation procedure specifying unit 33 starts the influencee operation procedure specifying processing illustrated in this FIG. 22 in step SP21 of the change notification information reception processing and firstly acquires all pieces of information registered in the diversion management table 39 (FIG. 11) (hereinafter referred to as the diversion-related information) (SP30).

Subsequently, the influencee operation procedure specifying unit 33 creates a list in which only operation procedures (the related operation procedures) having the diversion relation with the changed operation procedure (hereinafter referred to as the changed source operation procedure) on the basis of the diversion-related information acquired in step SP30 (hereinafter referred to as the diversion-related operation procedure list) and also creates the aforementioned influencee operation procedure list which is empty (SP31).

Then, the influencee operation procedure specifying unit 33 selects one unprocessed related operation procedure from among the related operation procedures registered in the diversion-related operation procedure list (SP32) and compares the selected related operation procedure with a task configuration of the changed source operation procedure (SP33).

Furthermore, the influencee operation procedure specifying unit 33 determines whether the task configuration of the related operation procedure selected in step SP32 matches that of the changed source operation procedure or not, on the basis of the comparison result in step SP33 (SP34). Then, if the influencee operation procedure specifying unit 33 obtains a negative result in this determination, this proceeds to step SP36.

On the other hand, if the influencee operation procedure specifying unit 33 obtains an affirmative result in the determination of step SP34, it registers the related operation procedure selected in step SP32 in the influencee operation procedure list created in step SP31(SP35).

Subsequently, the influencee operation procedure specifying unit 33 determines whether or not the execution of the processing from step SP32 to step SP35 has been completed with respect to all the related operation procedures registered in the diversion-related operation procedure list (SP36). Then, when the influencee operation procedure specifying unit 33 obtains a negative result in this determination, it returns to step SP and then repeats the processing from step SP32 to step SP36 by sequentially switching the related operation procedure selected in step SP32 to another unprocessed related operation procedure.

When the influencee operation procedure specifying unit 33 eventually obtains an affirmative result in step SP36 by completing the execution of the processing from step SP32 to step SP35 with respect to all the related operation procedures registered in the diversion-related operation procedure list, it terminates this influencee operation procedure specifying processing.

### (1-4-3) Change Message Display Processing

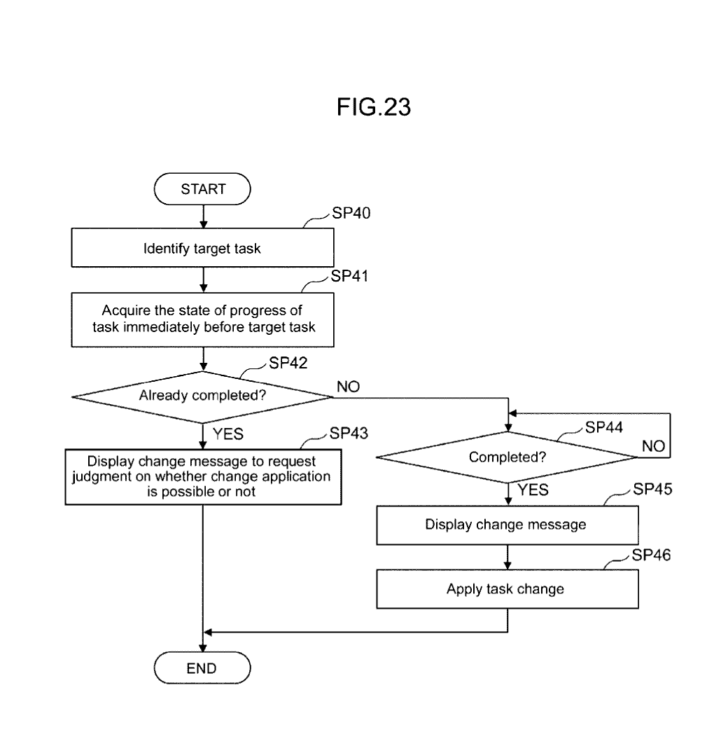

Meanwhile, FIG. 23 illustrates a processing sequence for the change message display processing executed by the notification determination unit 52 (FIG. 1) for the client terminal 2 which has received the change notification from the operation procedure support server 3. Incidentally, this FIG. 23 is an example of a case where “immediately after the completion of a task immediately preceding the target task” is set as the notification condition.

After the notification condition accepting unit 50 (FIG. 1) receives the change notification from the operation procedure support server 3 and the notification condition registration unit 51 (FIG. 1) registers the received change notification in the notification condition table 54 (FIG. 1), the notification determination unit 52 starts this change message display processing and firstly extracts the notification condition from the change notification information received by the notification condition accepting unit 50 and identifies a target task (hereinafter referred to as the target task) on the basis of the relevant change notification (SP40).

Subsequently, the notification determination unit 52 acquires the state of progress of the task executed immediately preceding the identified target task according to the notification condition (hereinafter referred to as the previous task) from the internal information (SP41) and determines whether such previous task has already been completed or not, on the basis of the state of progress (SP42).

Then, when the notification determination unit 52 obtains an affirmative result in this determination, it issues an instruction to the display unit 53 to display the change message described earlier with reference to FIG. 19 to request a determination on whether to apply a change of the task on the basis of the change notification (SP43). Subsequently, after the operator taps the OK button 111 which is displayed together with the change message, the notification determination unit 52 deletes that change message and then terminates this change message display processing.

On the other hand, if the notification determination unit 52 obtains a negative result in the determination of step SP42, it waits for the previous task of the target task as identified in step SP40 to be completed (SP44). Then, when the notification determination unit 52 eventually detects the completion of the previous task of the target task by the operator on the basis of the operator's operation input, the notification determination unit 52 issues an instruction to the display unit 53 to display the change message described earlier with reference to FIG. 18 according to the content of the then received change notification (SP45).

Subsequently, when the operator taps the apply button 101 displayed together with such change message, the notification determination unit 52 applies the change of the task (the change of the operation procedure) based on the change notification with respect to the current operation procedure (SP46) and then terminates this change message display processing.

### (1-5) Specific Example

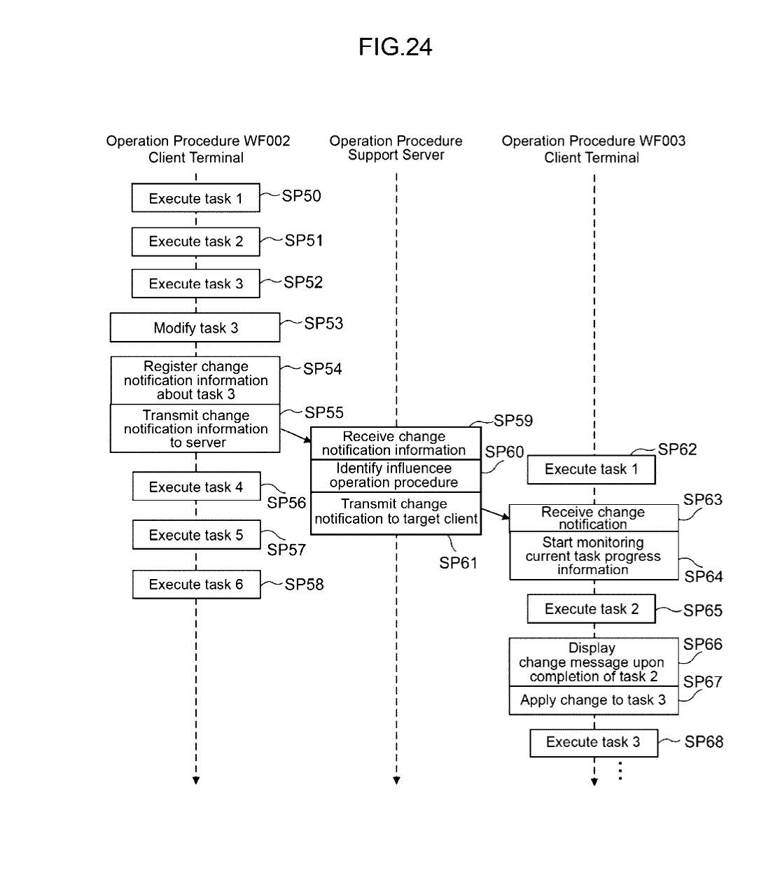

Next, an explanation will be given with reference to FIG. 24 regarding a specific processing flow in which a change of a task performed by the operator who conducts a certain operation procedure by means of the above-described operation procedure change notification function is reflected in operation procedures having the diversion relation with the relevant operation procedure.

Incidentally, FIG. 24 illustrates a flow in which an operator who conducts an operation procedure “WF002” composed of six tasks “task1” to “task6” updates a task “task3” and the update content is reflected in an operation procedure “WF003” which is started after the relevant operation procedure and has the diversion relation with the relevant operation procedure.

Firstly, the operator who conducts the operation procedure “WF002” conducts two tasks “task1” and “task2” sequentially (SP50, SP51). Then, when the operator finds upon executing a subsequent task “task3” that such task needs to be modified (SP52), the operator operates the client terminal 2 to modify “task3” (SP53).

As a result, the client terminal 2 generates change notification information regarding the modification of the task “task3”, registers the generated change notification information in the notification condition table 54 (FIG. 1) (SP54), and then transmits the relevant change notification information to the operation procedure support server 3 (S55P).

Subsequently, after the completion of the updated task “task3,” the operator conducts subsequent tasks “task4” to “task6” sequentially (SP56 to SP58).

Meanwhile, when the operation procedure support server 3 receives the change notification information transmitted from the client terminal 2 in step SP55 (SP59), it executes the processing described earlier with reference to FIG. 21 and FIG. 22, thereby identifying an operation procedure “WF003” having the diversion relation with the operation procedure “WF002” recognized on the basis of the change notification information (SP60).

Then, the operation procedure support server 3 transmits a change notification according to such change notification information to a client terminal 2 retained by an operator who conducts the identified operation procedure “WF003” (SP61).

On the other hand, when the client terminal 2 retained by the operator who is conducting the operation procedure “WF003” receives the change notification transmitted by the operation procedure support server 3 in step SP61 during the execution of, for example, the task “task1” (SP63), it starts monitoring the state of progress of the task (SP64).

Then, when the operator conducts each of “task1” and “task2” (SP62, SP65) and enters the operation input to report the completion of the task “task2” after such completion, the client terminal 2 displays the change message described earlier with reference to FIG. 18 on the operation procedure execution screen 60 on the basis of the change notification received in step SP63 (SP66); and subsequently, when the operator taps the apply button 101 (FIG. 18), the client terminal 2 applies such change to the operation procedure which is currently being executed (SP67). Accordingly, that operator conducts a task “task3” in accordance with the operation procedure to which the change is applied (SP68); and then conducts subsequent tasks “task4” to “task6” sequentially.

### (1-6) Advantageous Effects of this Embodiment

Regarding the operation procedure management system 1 according to this embodiment as described above, when the operator changes an operation procedure by using their own client terminal 2, a client terminal 2 retained by an operator who conducts an operation procedure having the diversion relation with the above-mentioned operation procedure is immediately notified of such change. Then, the client terminal 2 which has received such notification monitors the state of progress of the operation procedure by the operator and displays a change message upon the completion of a task immediately preceding the changed task.

Therefore, with this operation procedure management system 1, the client terminal 2 can display the change message at an appropriate timing and notify the operator of the change of such operation procedure at an appropriate timing, so that it is possible to effectively prevent the degradation of the operation quality or the occurrence of accidents.

Furthermore, this operation procedure management system 1 can display the change message at an appropriate timing, so that it is possible to avoid wasteful display of the change message and efficiently support the execution of the operation procedure.

### (2) Second Embodiment

### (2-1) Configuration of Operation Procedure Management System According to this Embodiment

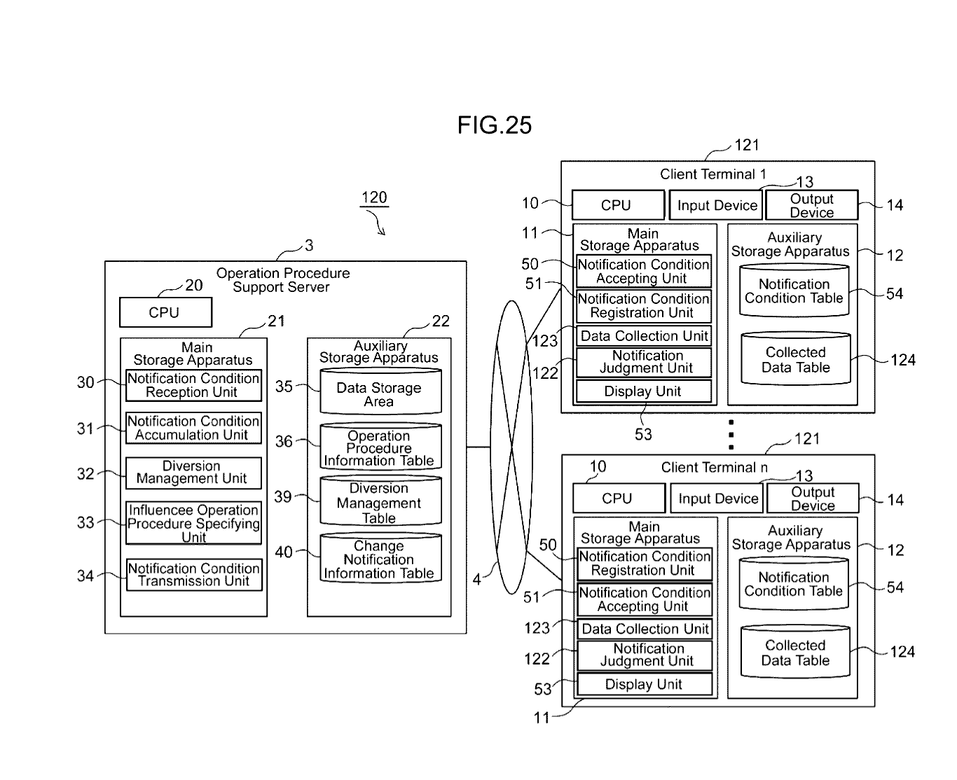

FIG. 25 which indicates parts corresponding to those in FIG. 1 by assigning them with the same reference numerals as in FIG. 1 illustrates an operation procedure management system 120 according to a second embodiment. This operation procedure management system 120 is characterized in that when an operator conducts a task, a client terminal 121 of the operator collects information regarding the task (which is information such as an identifier, manufacturing year, and manufacturer of a target device or component of the task and will be hereinafter referred to as the task information) from, for example, display information such as a bar code or a two-dimensional code (hereinafter referred to as the two-dimensional code) and the client terminal 121 determines whether to display a change message or not, on the basis of the collected task information.

Practically, with this operation procedure management system 120, the task information of each task constituting the operation procedure conducted by the operator is displayed for each operator as the two-dimensional code on, for example, the target device or component of the task with respect to each task. Furthermore, the client terminal 121 is equipped with a two-dimensional code reader function to read information from such two-dimensional code.

Then, the operator has the client terminal 121 acquire the task information of the task which is recorded as the two-dimensional code, by holding the client terminal 121 over the two-dimensional code indicated on the device or component before starting the task.

Subsequently, when a change notification is transmitted from the operation procedure support server 3, the client terminal 121 compares a notification condition included in the change notification with the task information, which the operator has acquired as described above, of each task which has been conducted by the operator, and displays the change message described earlier with respect to FIG. 18 or FIG. 19 at a specified timing on the basis of the comparison result.

In a case of the operation procedure management system 120 according to this embodiment, a data collection unit 123 is stored, in addition to the notification condition accepting unit 50, the notification condition registration unit 51, the notification determination unit 122, and the display unit 53, in the main storage apparatus 11 of the client terminal 121 and a collected data table 124 is stored, in addition to the notification condition table 54, in the auxiliary storage apparatus 12 of the client terminal 121 as means for implementing an operation procedure change notification function according to this embodiment as described above as illustrated in FIG. 25.

The data collection unit 123 is a program having a function that reads (or collects) the task information of a task, which the operator intends to conduct next, from, for example, the two-dimensional code according to the operator's operation when executing the task of the operation procedure. The data collection unit 123 registers the collected task information in the collected data table 124.

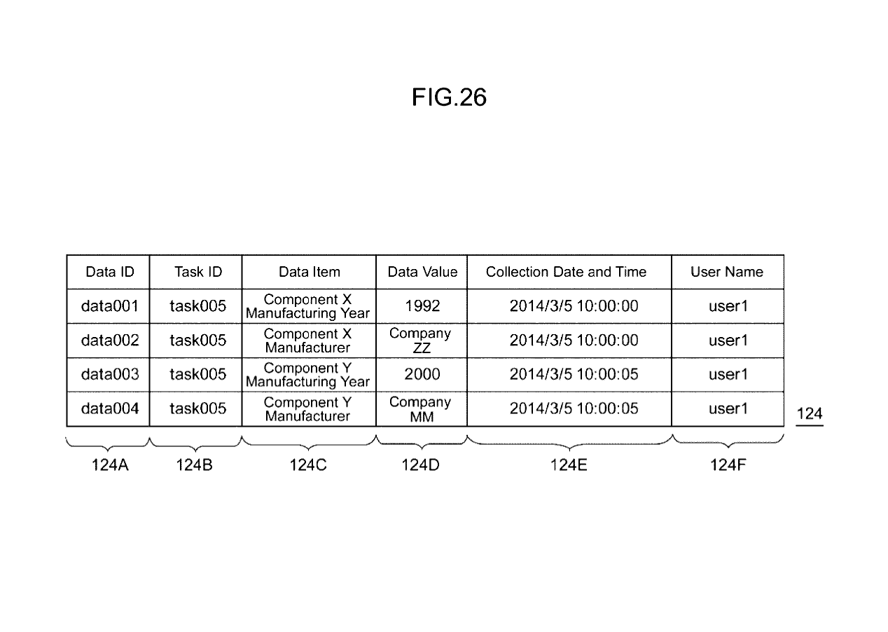

The collected data table 124 is a table used to manage the task information of each task which has been collected by the data collection unit 123. This collected data table 124 is composed of a data ID column 124A, a task ID column 124B, a data item column 124C, a data value column 124D, a collection date and time column 124E, and a user name column 124F as illustrated in FIG. 26.

Then, the data ID column 124A stores a unique identifier of the relevant task information (data ID) which is assigned to the task information collected by the data collection unit 123; and the task ID column 124B stores a task ID of the task corresponding to the task information.

Furthermore, the data item column 124C stores an item name of a data item included in the corresponding task information; and the data value column 124D stores a data value of such data item. Furthermore, the collection date and time column 124E stores a date and time when the relevant task information was collected; and the user name column 124F stores an identifier (user name) of the operator who conducted the relevant task.

Therefore, an example of FIG. 26 shows that task information “data001” collected by an operator “user1” at “2014/3/5 10:00:00” corresponds to a task “task005” and its content indicated is that a “manufacturing year” of “component X” is “1992.”

### (2-2) Configuration of Task Addition Screen According to this Embodiment

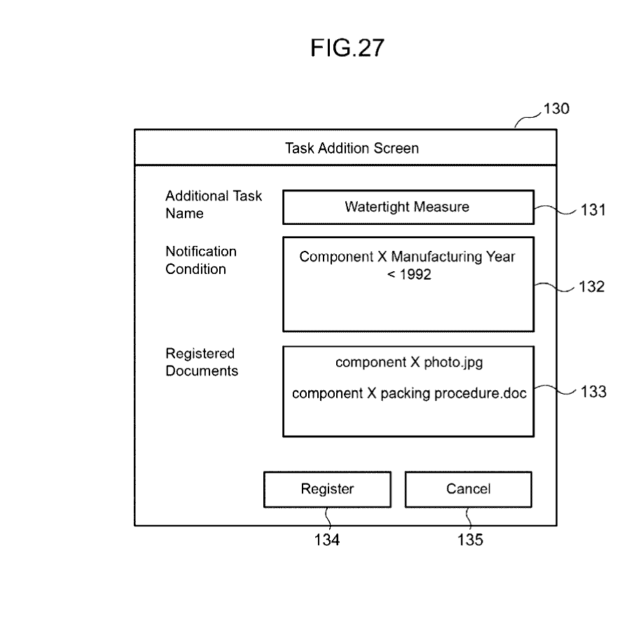

FIG. 27 illustrates a task addition screen 130 according to the embodiment, which is displayed when necessary on the client terminal 121 of this operation procedure management system 120, instead of the task addition screen 70 according to the first embodiment as described earlier with reference to FIG. 15. This task addition screen 130 is a screen to set a change of the operation procedure to add a new task immediately before a task selected on the operation procedure execution screen 60 (FIG. 13) (the selected task) and is composed of an additional task name field 131, a notification condition field 132, a registered document field 133, a register button 134, and a cancel button 135.

Functions and configurations of the additional task name field 131, the registered document field 133, the register button 134, and the cancel button 135 are the same as those of the corresponding parts of the task addition screen 70 (FIG. 15) according to the first embodiment.

However, this task addition screen 130 is provided with only one notification condition field 132 and a notification condition which utilizes the task information can be set (or input) to this notification condition field 132 in addition to or instead of the timing to display the change message described earlier with reference to FIG. 18. For example, FIG. 27 shows an example in which when the “manufacturing year” of “component X” which is a target of the task is before “1992,” information indicating that the change message should be displayed on the client terminal 121 of the operator who conducts the relevant related operation procedure is set as the notification condition.

This notification condition can be set freely by the operator and a plurality of notification conditions can be also set. In this case, when all the notification conditions are set, the aforementioned change message is displayed on the client terminal 2. Furthermore, the notification condition operator may input the notification condition in a form of a character string into the notification condition field 132 or a notification condition which can be set by utilizing the task information of that task may be displayed as a default value.

Since other screens displayed on the client terminal 121 are the same as those in the first embodiment, an explanation regarding them has been omitted.

### (2-3) Change Message Display Processing According to this Embodiment

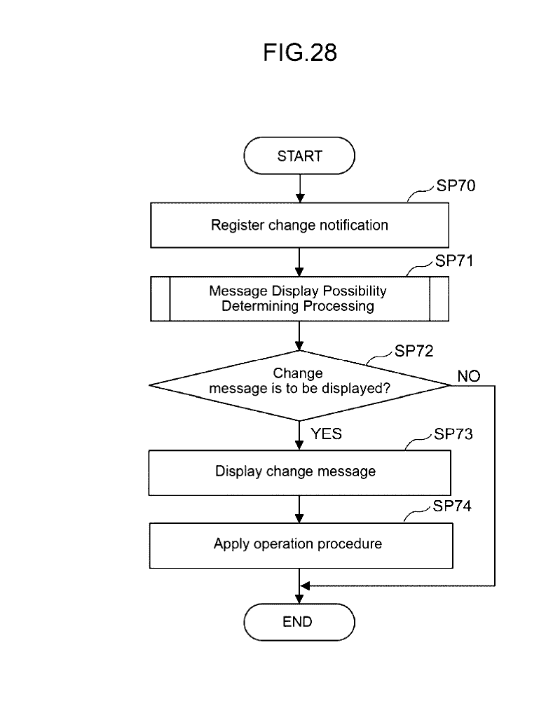

FIG. 28 illustrates a processing sequence for change message display processing executed according to this embodiment by the client terminal 121 which has received the change notification from the operation procedure support server 3. Regarding the client terminal 121, after the notification condition accepting unit 50 receives the change notification, change message display processing illustrated in this FIG. 28 is started; and the notification condition registration unit 51 (FIG. 25) firstly registers the change notification, which has been received by the notification condition accepting unit 50, in the notification condition table 54 (FIG. 25) (SP70).

Subsequently, the notification determination unit 122 executes message display possibility determining processing for extracting the notification condition from such change notification and determining whether or not to display the change message described earlier with reference to FIG. 18 and FIG. 19, on the basis of the extracted notification condition and the task information registered in the collected data table 124 (FIG. 26) (SP71). Then, the notification determination unit 122 determines whether to display the change message or not, on the basis of the determination result of this message display possibility determining processing (SP72); and if the notification determination unit 122 obtains a negative result, it terminates this change message display processing.

On the other hand, if the notification determination unit 122 obtains an affirmative result in step SP72, it gives an instruction to the display unit 53 (FIG. 25) to display the change message described earlier with reference to FIG. 18 and FIG. 19 (SP73). Furthermore, when operation input to approve a change of the operation procedure is entered by the operator (that is, when the apply button 101 in FIG. 18 or the OK button 111 in FIG. 19 is tapped), the notification determination unit 122 applies the change of the task (the change of the operation procedure) based on the change notification with respect to the current operation procedure (SP74) and then terminates this change message display processing.

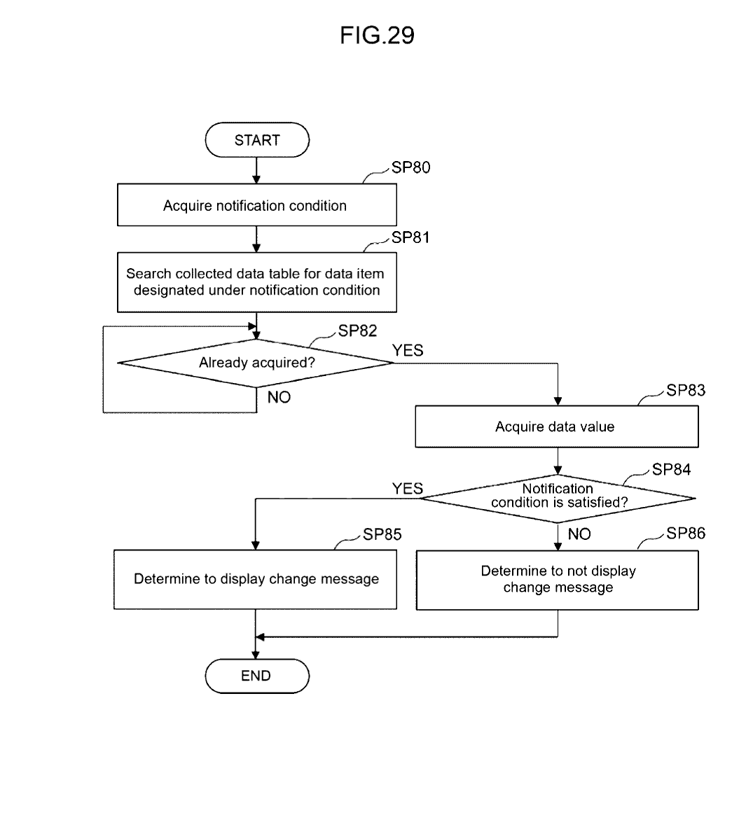

FIG. 29 illustrates a specific processing sequence for the above-mentioned message display possibility determining processing executed by the notification determination unit 122 in step SP71 of such change message display processing. As the notification determination unit 122 proceeds to step SP71 of such change message display processing, it starts the message display possibility determining processing illustrated in this FIG. 29 and firstly acquires a change condition included in the change notification registered in the notification condition table 54 by the notification condition registration unit 51 in step SP70 of the change message display processing (SP80).

Subsequently, the notification determination unit 122 searches the collected data table 124 for a data value of a data item designated by the notification condition acquired in step SP80 (SP81) and determines whether such data value has already been acquired or not (whether such data value has been successfully detected or not) (SP82).

Obtaining a negative result in this determination means that the operator who retains that client terminal 121 has not executed the target task yet. Accordingly, the notification determination unit 122 then waits for the data value of the data item designated by the notification condition acquired in step SP80 to be registered in the collected data table 124 (SP82).

Then, when the data value of such data item is eventually registered in the collected data table 124, the notification determination unit 122 acquires the data value (SP83) and determines whether or not the acquired satisfies the notification condition acquired in step SP80 (SP84).

If the notification determination unit 122 obtains an affirmative result in this determination, it determines to display the change message (SP85) and then terminates this message display possibility determining processing and returns to the change message display processing (FIG. 27).

On the other hand, if the notification determination unit 122 obtains a negative result in the determination of step SP84, it determines to not display the change message (SP86) and then terminates this message display possibility determining processing and returns to the change message display processing.

### (2-4) Advantageous Effects of this Embodiment

The operation procedure management system 120 according to this embodiment as described above has the client terminal 121 compare the notification condition, which is included in the change notification transmitted from the operation procedure support server 3, with the task information of each task, which has been acquired, and display the change message at a specified timing on the basis of the comparison result.

Accordingly, this operation procedure management system 120 can set, as notification conditions, not only the timing to display the change message, but also items which can be registered as the task information, and can thereby set more detailed notification conditions than in the first embodiment.

### (3) Other Embodiments

Incidentally, the aforementioned first and second embodiments have described the case where the notification condition reception unit 30, the notification condition accumulation unit 31, the diversion management unit 32, the influencee operation procedure specifying unit 33, the notification condition transmission unit 34, the notification condition accepting unit 50, the notification condition registration unit 51, the notification determination unit 52, the display unit 53, and the data collection unit 123 for the operation procedure management system 1, 120 are configured as programs; however, the present invention is not limited to this example and some of them may be configured as hardware.

Moreover, the aforementioned first and second embodiments have described the case where the operation procedure is changed by the operator by using their client terminal 2, 121; however, the present invention is not limited to this example and, for example, the operation procedure may be changed by the operator informing another operator of the content of the operation procedure to be changed via telephone or the like during the operation or directly after the operation and by the other operator changing the operation procedure by using a computer device other than the client terminal 2, 121.

Furthermore, the aforementioned first and second embodiment have described the case where the client terminal 2, 121 displays the change message described earlier with reference to FIG. 18 or FIG. 19; however, the present invention is not limited to this example and other wide variety of configurations can be applied as the configuration of the change message.

Furthermore, the aforementioned second embodiment has described the case where the task information of each task is displayed as the two-dimensional code on a task target device or component with respect to each task; however, the present invention is not limited to this example and, for example, a code list in which the task information of each task is described as the two-dimensional code is lent, together with the client terminal 121, to the operator, so that when starting a task, the operator may use the client terminal 121 to read the corresponding two-dimensional code in the code list.

Furthermore, the aforementioned second embodiment has described the case where the task information of each task is displayed as the two-dimensional code; however, the present invention is not limited to this example and the task information of each task may be displayed by any other display method so that the client terminal 121 may be able to read such task information.

Furthermore, the aforementioned second embodiment has described the case where the client terminal 121 is equipped with the two-dimensional code reader function; however, the present invention is not limited to this example and a two-dimensional code reader may be prepared separately from the client terminal 121 so that the task information read from the two-dimensional code by the two-dimensional code reader may be transmitted to the client terminal 121.

### INDUSTRIAL APPLICABILITY

The present invention can be applied to operation procedure management systems of various configurations that manage a plurality of operation procedures executed at different sites.

### REFERENCE SIGNS LIST

1, 120: operation procedure management system
2, 121: client terminal
3: operation procedure support server
10, 20: CPU
11, 21: main storage apparatus
12, 22: auxiliary storage apparatus
13: input device
14: output device
30: notification condition reception unit
31: notification condition accumulation unit
32: diversion management unit
33: influencee operation procedure specifying unit
34: notification condition transmission unit
35: data storage area
36: operation procedure information table
37: task information table
38: document information table
39: diversion management table
40: change notification information table
50: notification condition accepting unit
51: notification condition registration unit
52, 122: notification determination unit
53: display unit
54: notification condition table
60: operation procedure execution screen
69: task operation menu
70, 130: task addition screen
80: task update screen
90: task deletion screen
100, 110: change message display area
101: apply button
111: OK button
123: data collection unit
124: collected data table

1. An operation procedure management method executed by an operation procedure management system including a plurality of client terminals, each of which is distributed to each of operators, and a server system for providing information regarding operation procedures to each of the operators,
wherein the server system includes:
a first storage apparatus storing necessary information for various kinds of processing; and
a first processing unit for executing the processing by referring to the information stored in the first storage apparatus,
wherein each of the client terminals includes:
a second storage apparatus storing necessary information for various kinds of processing;
a second processing unit for executing the processing by referring to the information stored in the second storage apparatus; and
an output device for displaying the information;
wherein the operation procedure management method comprising:
a first step executed by the first processing unit of the server system storing diversion-related information, which is information regarding a diversion relation between the operation procedures, in the storage apparatuses and managing the diversion-related information, and searching for, upon a change of one of the operation procedures, other operation procedures having the diversion relation with the changed operation procedure on the basis of the diversion-related information and transmitting changed contents as a change notification to the client terminal retained by the operator who conducts the operation procedure detected by the search; and
a second step executed by the second processing unit of the client terminal, which has received the change notification, displaying a message according to the changed contents of the operation procedure on the output device at an appropriate timing.

2. The operation procedure management method according to claim 1,
wherein the operation procedure is composed of a plurality of tasks;
wherein the change of the operation procedure is an addition, update, or deletion of a task;
wherein the appropriate timing is immediately after completion of a task immediately before the task which is added, updated, or deleted.

3. The operation procedure management method according to claim 2,
wherein the change of the operation procedure can be set by the operator by operating the client terminal;
wherein when the change of the operation procedure is set by the operator, the second processing unit transmits change notification information according to the set content to the server system;
wherein when the first processing unit receives the change notification information from the client terminal, the first processing unit searches for the other operation procedures having the diversion relation with the changed operation procedure, which is recognized according to the change notification information, on the basis of the diversion-related information.

4. The operation procedure management method according to claim 3,
wherein when changing the operation procedure, a notification condition to notify the operator, who conducts the other operation procedures having the diversion relation with the changed operation procedure, of the change is set;
wherein the change notification includes the notification condition;
wherein in the second step the second processing unit displays the message on the output device when the notification condition included in the change notification is satisfied.

5. The operation procedure management method according to claim 3,
wherein in the first step the first processing unit transmits the change notification to the client terminal retained by the operator who conducts the operation procedure with the same task configuration as that of the changed operation procedure, from among the other operation procedures having the diversion relation with the changed operation procedure;
wherein the second processing unit manages a state of progress of the operation procedure by the operator;
wherein in the second step the second processing unit displays the message on the output device when the state of progress of the operation procedure by the operator becomes a timing satisfying the notification condition included in the change notification.

6. The operation procedure management method according to claim 3,
wherein the client terminal includes a task information collection unit that collects task information regarding the task when the operator starts executing the task; and
wherein in the second step the second processing unit compares the notification condition included in the change notification with the information collected by the task information collection unit and determines whether the message should be displayed on the output device or not, on the basis of a comparison result.

7. An operation procedure management system comprising a plurality of client terminals, each of which is distributed to each of operators, and a server system for providing information regarding operation procedures to each of the operators,
wherein the server system includes:
a first storage apparatus storing necessary information for various kinds of processing; and
a first processing unit for executing the processing by referring to the information stored in the first storage apparatus,
wherein each of the client terminals includes:
a second storage apparatus storing necessary information for various kinds of processing;
a second processing unit for executing the processing by referring to the information stored in the second storage apparatus; and
an output device for displaying the information;
wherein the first processing unit: stores diversion-related information, which is information regarding a diversion relation between the operation procedures, in the storage apparatuses and manages the diversion-related information; and upon a change of one of the operation procedures, searches for other operation procedures having the diversion relation with the changed operation procedure on the basis of the diversion-related information and transmits changed contents as a change notification to the client terminal retained by the operator who conducts the operation procedure detected by the search;
wherein the second processing unit displays, upon receiving the change notification, a message according to the changed contents of the operation procedure on the output device at an appropriate timing.

8. The operation procedure management system according to claim 7,
wherein the operation procedure is composed of a plurality of tasks;
wherein the change of the operation procedure is an addition, update, or deletion of a task;
wherein the appropriate timing is immediately after completion of a task immediately before the task which is added, updated, or deleted.

9. The operation procedure management system according to claim 8,
wherein the change of the operation procedure can be set by the operator by operating the client terminal;
wherein when the change of the operation procedure is set by the operator, the second processing unit transmits change notification information according to the set content to the server system;
wherein when the first processing unit receives the change notification information from the client terminal, the first processing unit searches for the other operation procedures having the diversion relation with the changed operation procedure, which is recognized according to the change notification information, on the basis of the diversion-related information.

10. The operation procedure management system according to claim 9,
wherein upon the change of the operation procedure, a notification condition to notify the operator, who conducts the other operation procedures having the diversion relation with the changed operation procedure, of the change is set;
wherein the change notification includes the notification condition;
wherein the second processing unit displays the message on the output device when the notification condition included in the change notification is satisfied.

11. The operation procedure management system according to claim 9,
wherein the first processing unit transmits the change notification to the client terminal retained by the operator who conducts the operation procedure with the same task configuration as that of the changed operation procedure, from among the other operation procedures having the diversion relation with the changed operation procedure;
wherein the second processing unit: manages a state of progress of the operation procedure by the operator; and displays the message on the output device when the state of progress of the operation procedure by the operator becomes a timing satisfying the notification condition included in the change notification.

12. The operation procedure management system according to claim 9,
wherein the client terminal includes a task information collection unit that collects task information regarding the task when the operator starts executing the task; and
wherein the second processing unit compares the notification condition included in the change notification with the information collected by the task information collection unit and determines whether the message should be displayed on the output device or not, on the basis of a comparison result.
